(19) United States
(12) Patent Application Publication
(10) Pub. No.: US 2023/0323179 A1
(43) Pub. Date: Oct. 12, 2023

(54) REFRIGERANT-CONTAINING COMPOSITION, USE THEREOF, REFRIGERATOR HAVING SAME, AND METHOD FOR OPERATING SAID REFRIGERATOR

(71) Applicant: DAIKIN INDUSTRIES, LTD., Osaka (JP)

(72) Inventors: Mitsushi ITANO, Osaka (JP); Shun OHKUBO, Osaka (JP); Daisuke KARUBE, Osaka (JP)

(73) Assignee: DAIKIN INDUSTRIES, LTD., Osaka (JP)

(21) Appl. No.: 18/209,046

(22) Filed: Jun. 13, 2023

Related U.S. Application Data
(63) Continuation of application No. PCT/JP2021/046094, filed on Dec. 14, 2021.

(30) Foreign Application Priority Data
Dec. 14, 2020 (JP) 2020-206857

(51) Int. Cl. C09K 5/04

(52) U.S. Cl. CPC C09K 5/045; C09K 2205/122; C09K 2205/126

(57) ABSTRACT

An object is to provide a novel low-GWP mixed refrigerant. As a solution to achieve the object, a composition containing a refrigerant that contains 1,1-difluoroethylene (HFO-1132a), difluoromethane (R32), and 1,3,3,3-tetrafluoropropene (R1234ze) is provided.

### TECHNICAL FIELD

The present disclosure relates to a composition comprising a refrigerant, use of the composition, a refrigerating machine comprising the composition, and a method for operating the refrigerating machine.

### BACKGROUND ART

R410A is currently used as an air conditioning refrigerant for home air conditioners etc. R410A is a two-component mixed refrigerant of difluoromethane (CH₂F₂; HFC-32 or R32) and pentafluoroethane (C₂HF₅; HFC-125 or R125) and is a pseudo-azeotropic composition.

However, the global warming potential (GWP) of R410A is 2088. Due to growing concerns about global warming, R32, which has a GWP of 675, has been increasingly used.

For this reason, various low-GWP mixed refrigerants that can replace R410A have been proposed (Patent Literature 1).

### CITATION LIST

### Patent Literature

PTL 1: WO2015/141678

### SUMMARY

Item 1.

A composition comprising a refrigerant, the refrigerant comprising 1,1-difluoroethylene (HFO-1132a), difluoromethane (R32), and 1,3,3,3-tetrafluoropropene (R1234ze).

### Advantageous Effects

The refrigerant according to the present disclosure has a low GWP.

### BRIEF DESCRIPTION OF DRAWINGS

FIG. 1 is a diagram showing points A to J, A′, B′, and G′, and line segments that connect these points to each other in a ternary composition diagram in which the sum of R32, HFO-1132a, and R1234ze is 100 mass %.

FIG. 2 is a diagram showing points A to H, P, A′, B′, C′, G′, and E′, and line segments that connect these points to each other in a ternary composition diagram in which the sum of R32, R1234yf, and R1234ze is 98.5 mass % (HFO-1132a content is 1.5 mass %).

FIG. 3 is a diagram showing points A to H, P, A′, and B′, and line segments that connect these points to each other in a ternary composition diagram in which the sum of R32, R1234yf, and R1234ze is 98.5 mass % (HFO-1132a content is 1.5 mass %).

FIG. 4 is a diagram showing points A to H, P, A′, and B′, and line segments that connect these points to each other in a ternary composition diagram in which the sum of R32, R1234yf, and R1234ze is 97.0 mass % (HFO-1132a content is 3.0 mass %).

FIG. 5 is a diagram showing points A to H, P, A′, and B′, and line segments that connect these points to each other in a ternary composition diagram in which the sum of R32, R1234yf, and R1234ze is 95.0 mass % (HFO-1132a content is 5.0 mass %).

FIG. 6 is a diagram showing points A to H, P, A′, and B′, and line segments that connect these points to each other in a ternary composition diagram in which the sum of R32, R1234yf, and R1234ze is 92.5 mass % (HFO-1132a content is 7.5 mass %). FIG. 7 is a diagram showing points A to H, P, A′, and B′, and line segments that connect these points to each other in a ternary composition diagram in which the sum of R32, R1234yf, and R1234ze is 90.0 mass % (HFO-1132a content: 10.0 mass %).

FIG. 8 is a diagram showing points A″, B″, L, M, S, and T, and line segments that connect these points to each other in a ternary composition diagram in which the sum of R32, HFO-1132a, and R1234ze is 100 mass %.

FIG. 9 is a diagram showing points A″, B″, L, L′, M, and T, and line segments that connect these points to each other in a ternary composition diagram in which the sum of R32, R1234yf, and R1234ze is 98.5 mass % (HFO-1132a content is 1.5 mass %).

FIG. 10 is a diagram showing points A″, B″, L, L′, M, and T, and line segments that connect these points to each other in a ternary composition diagram in which the sum of R32, R1234yf, and R1234ze is 98.5 mass % (HFO-1132a content is 1.5 mass %).

FIG. 11 is a diagram showing points A″, B″, L, M, and T, and line segments that connect these points to each other in a ternary composition diagram in which the sum of R32, R1234yf, and R1234ze is 98.1 mass % (HFO-1132a content is 1.9 mass %).

FIG. 12 is a diagram showing points A″, B″, L, and M, and line segments that connect these points to each other in a ternary composition diagram in which the sum of R32, R1234yf, and R1234ze is 94.0 mass % (HFO-1132a content is 6.0 mass %).

FIG. 13 is a diagram showing points A″, B″, L, and M, and line segments that connect these points to each other in a ternary composition diagram in which the sum of R32, R1234yf, and R1234ze is 90.0 mass % (HFO-1132a content is 10.0 mass %).

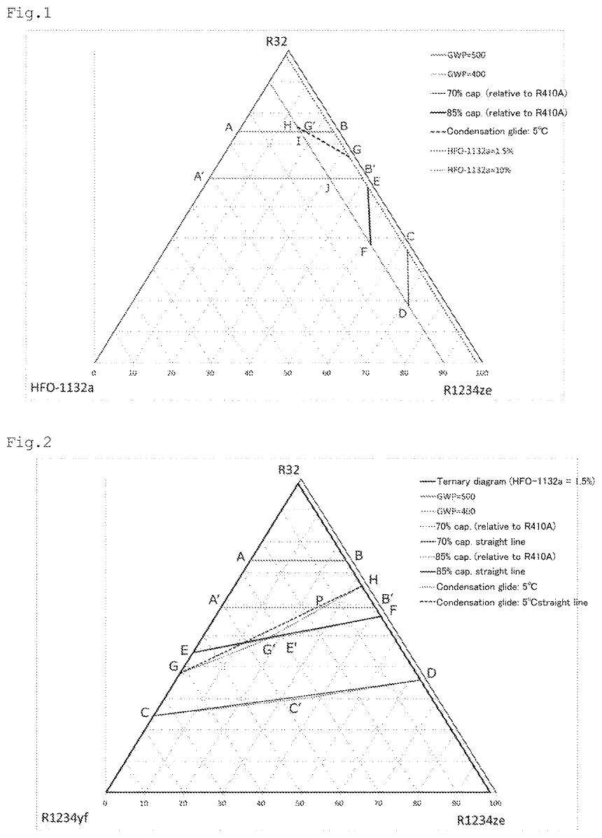

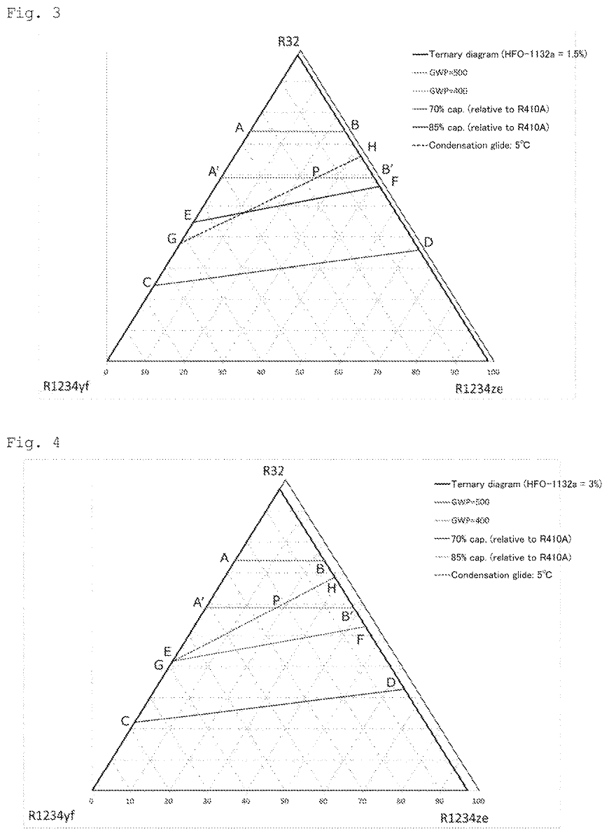

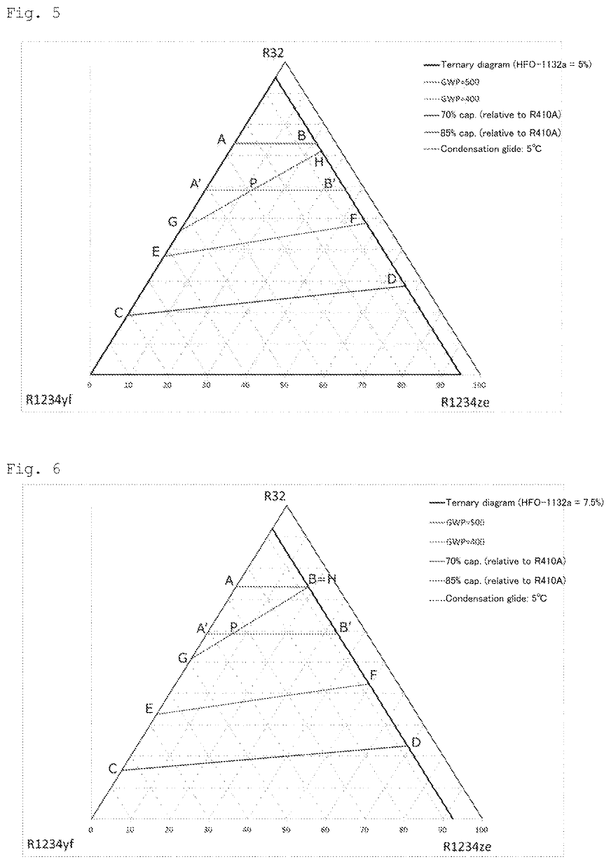

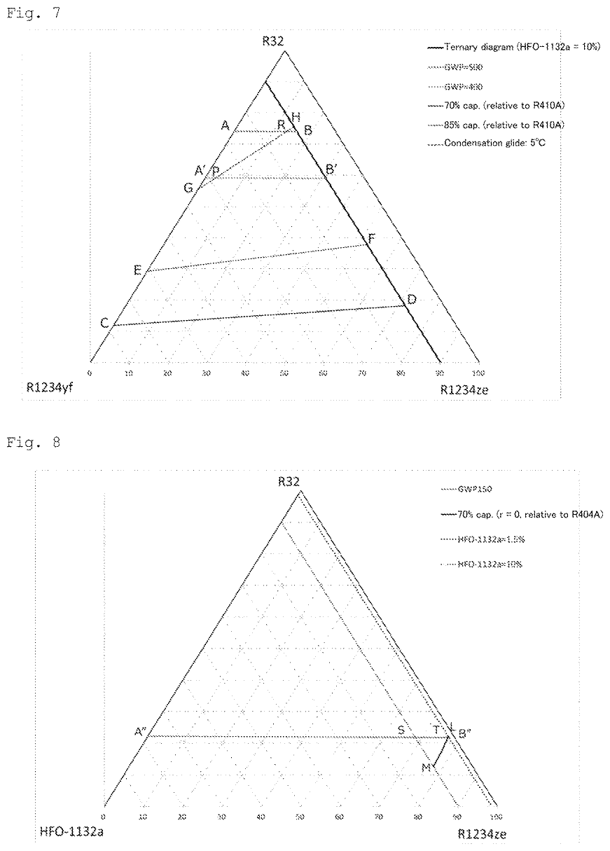

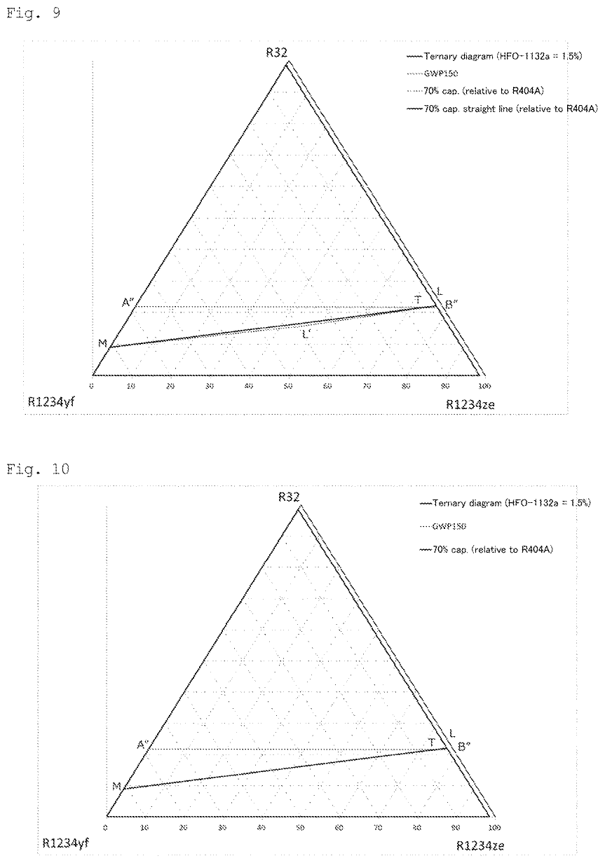

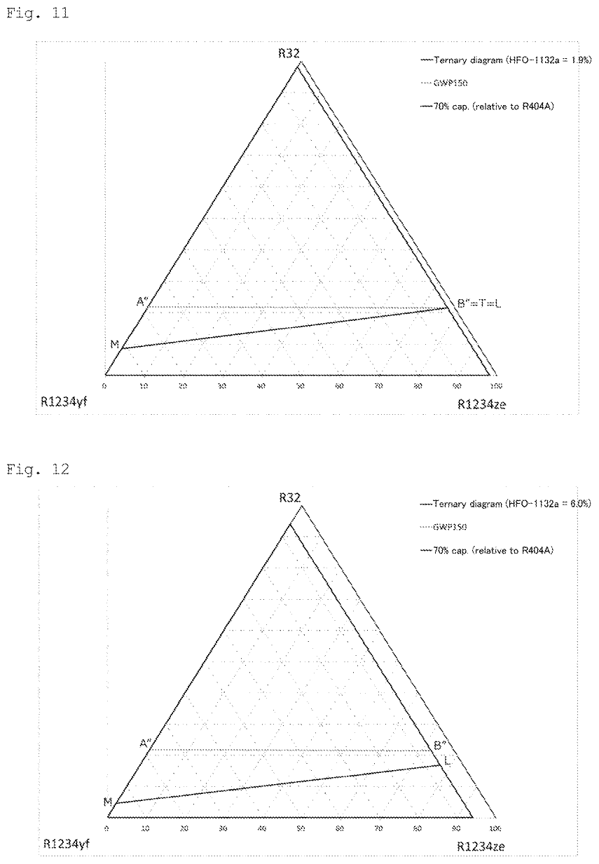

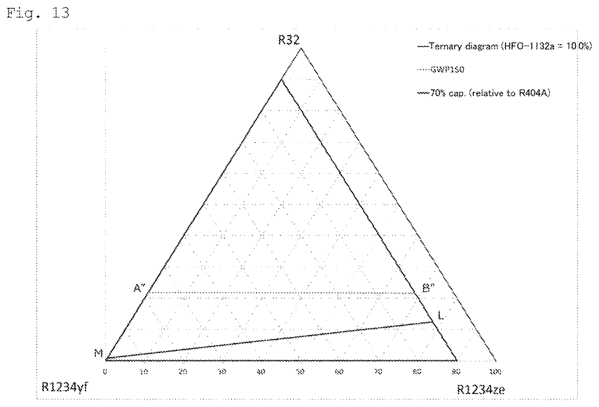

### DESCRIPTION OF EMBODIMENTS

The present inventors conducted intensive study to solve the above problem, and consequently found that a mixed refrigerant comprising HFO-1132a, R32, and R1234ze has the above properties.

The present disclosure has been completed as a result of further research based on this finding. The present disclosure includes the following embodiments.

### DEFINITION OF TERMS

In the present specification, the term “refrigerant” includes at least compounds that are specified in ISO 817 (International Organization for Standardization), and that are given a refrigerant number (ASHRAE number) representing the type of refrigerant with “R” at the beginning; and further includes refrigerants that have properties equivalent to those of such refrigerants, even though a refrigerant number is not yet given. Refrigerants are broadly divided into fluorocarbon compounds and non-fluorocarbon compounds in terms of the structure of the compounds. Fluorocarbon compounds include chlorofluorocarbons (CFC), hydrochlorofluorocarbons (HCFC), and hydrofluorocarbons (HFC).

In the present specification, the phrase “composition comprising a refrigerant” at least includes (1) a refrigerant itself (including a mixture of refrigerants), (2) a composition that further comprises other components and that can be mixed with at least a refrigeration oil to obtain a working fluid for a refrigerating machine, and (3) a working fluid for a refrigerating machine containing a refrigeration oil. In the present specification, of these three embodiments, the composition (2) is referred to as a “refrigerant composition” so as to distinguish it from a refrigerant itself (including a mixture of refrigerants). Further, the working fluid for a refrigerating machine (3) is referred to as a “refrigeration oil-containing working fluid” so as to distinguish it from the “refrigerant composition.”

In the present specification, when the term “alternative” is used in a context in which the first refrigerant is replaced with the second refrigerant, the first type of “alternative” means that equipment designed for operation using the first refrigerant can be operated using the second refrigerant under optimum conditions, optionally with changes of only a few parts (at least one of the following: refrigeration oil, gasket, packing, expansion valve, dryer, and other parts) and equipment adjustment. In other words, this type of alternative means that the same equipment is operated with an alternative refrigerant. Embodiments of this type of “alternative” include “drop-in alternative,” “nearly drop-in alternative,” and “retrofit,” in the order in which the extent of changes and adjustment necessary for replacing the first refrigerant with the second refrigerant is smaller.

The term “alternative” also includes a second type of “alternative,” which means that equipment designed for operation using the second refrigerant is operated for the same use as the existing use with the first refrigerant by using the second refrigerant. This type of alternative means that the same use is achieved with an alternative refrigerant.

In the present specification, the term “refrigerating machine” refers to machines in general that draw heat from an object or space to make its temperature lower than the temperature of ambient air, and maintain a low temperature. In other words, refrigerating machines refer to conversion machines that gain energy from the outside to do work, and that perform energy conversion, in order to transfer heat from where the temperature is lower to where the temperature is higher.

In the present specification, the term “condensation temperature glide” refers to the temperature gradient in which the condensation start temperature and the condensation end temperature in a heat exchanger differ due to the difference in composition between the liquid phase and the gas phase in a non-azeotropic mixed refrigerant as described herein.

### 1. Refrigerant

### 1.1 Essential Refrigerant Components

The refrigerant according to the present disclosure comprises HFO-1132a, R32, and R1234ze.

The refrigerant according to the present disclosure is a low-GWP mixed refrigerant.

The refrigerant according to the present disclosure preferably comprises HFO-1132a in an amount of 1.5 to 10 mass % based on the entire refrigerant. The content of R32 is preferably 74 mass % or less, and more preferably 59 mass % or less, based on the entire refrigerant. When the refrigerant is an alternative refrigerant for R404A, the content of R32 is more preferably 21.8 mass % or less.

When the refrigerant according to the present disclosure comprises HFO-1132a, R32, R1234ze, and R1234yf, and when the refrigerant is an alternative refrigerant for R410A, the content of R32 is preferably 11.9 mass % or more, more preferably 29.1 mass % or more, and even more preferably 37.9 mass % or more, based on the entire refrigerant. The total content of R1234ze and R1234yf is preferably 14.5 mass % or more, more preferably 16.0 mass % or more, and even more preferably 31.0 mass % or more, based on the entire refrigerant. The content of R1234ze is preferably 71.8 mass % or less, more preferably 52.3 mass % or less, and even more preferably 32.6 mass % or less, based on the entire refrigerant. The content of R1234yf is preferably 78.1 mass % or less, more preferably 60.9 mass % or less, and even more preferably 60.6 mass % or less, based on the entire refrigerant.

When the refrigerant according to the present disclosure comprises HFO-1132a, R32, R1234ze, and R1234yf, and when the refrigerant is an alternative refrigerant for R404A, the content of R32 is preferably 0.9 mass % or more based on the entire refrigerant. The total content of R1234ze and R1234yf is preferably 68.2 mass % or more based on the entire refrigerant. The content of R1234ze is preferably 77.5 mass % or less based on the entire refrigerant. The content of R1234yf is preferably 89.6 mass % or less based on the entire refrigerant.

The refrigerant according to the present disclosure preferably satisfies the following requirements. In this case, the refrigerant according to the present disclosure has a GWP of 500 or less and a refrigerating capacity ratio of 70% or more relative to that of R410A.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines IB, BC, CD, and DI that connect the following four points:
point I (10.0, 74.0, 16.0),
point B (1.5, 73.9, 24.6),
point C (1.5, 35.8, 62.7), and
point D (10.0, 18.2, 71.8),
or on the straight lines.

The refrigerant according to the present disclosure preferably satisfies the following requirements. In this case, the refrigerant according to the present disclosure has a GWP of 500 or less and a refrigerating capacity ratio of 85% or more relative to that of R410A.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines IB, BE, EF, and FI that connect the following four points:
point I (10.0, 74.0, 16.0),
point B (1.5, 73.9, 24.6),
point E (1.5, 56.2, 42.3), and
point F (10.0, 37.7, 52.3),
or on the straight lines.

The refrigerant according to the present disclosure preferably satisfies the following requirements. In this case, the refrigerant according to the present disclosure has a GWP of 500 or less and a condensation temperature glide of 5° C. or less.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines G′B, BG, and GG′ that connect the following three points:
point G′ (8.6, 73.9, 17.5),
point B (1.5, 73.9, 24.6), and
point G (1.5, 65.9, 32.6),
or on the straight lines.

The refrigerant according to the present disclosure preferably satisfies the following requirements. In this case, the refrigerant according to the present disclosure has a GWP of 400 or less and a refrigerating capacity ratio of 70% or more relative to that of R410A.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines JB′, B′C, CD, and DJ that connect the following four points:
point J (10.0, 59.0, 31.0),
point B′ (1.5, 58.9, 39.6),
point C (1.5, 35.8, 62.7), and
point D (10.0, 18.2, 71.8),
or on the straight lines.

The refrigerant according to the present disclosure preferably satisfies the following requirements. In this case, the refrigerant according to the present disclosure has a GWP of 400 or less and a refrigerating capacity ratio of 85% or more relative to that of R410A.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines JB′, B′E, EF, and FJ that connect the following four points:
point J (10.0, 59.0, 31.0),
point B′ (1.5, 58.9, 39.6),
point E (1.5, 56.2, 42.3), and
point F (10.0, 37.7, 52.3),
or on the straight lines.

The refrigerant according to the present disclosure may further comprise 2,3,3,3-tetrafluoro-1-propene (R1234yf).

When the refrigerant according to the present disclosure further comprises R1234yf, the refrigerant preferably satisfies the following requirements. In this case, the refrigerant according to the present disclosure has a GWP of 500 or less and a refrigerating capacity ratio of 70% or more relative to that of R410A.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines AB, BC, CD, and DA that connect the following four points:
point A (74.0, −a+26.0, 0.0),
point B (73.9, 0.0, −a+26.1),
point D (0.0098a²−2.1856a+39.064, 0.0, −0.0098a²+1.1856a+60.936), and
point C (0.0138a²−1.6252a+26.785, −0.0138a²+0.6252a+73.215, 0.0),
or on the straight lines AB and CD (excluding the points A, B, C, and D).

When the refrigerant according to the present disclosure further comprises R1234yf, the refrigerant preferably satisfies the following requirements. In this case, the refrigerant according to the present disclosure has a GWP of 500 or less and a refrigerating capacity ratio of 85% or more relative to that of R410A.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines AB, BF, FE, and EA that connect the following four points:
point A (74.0, −a+26.0, 0.0),
point B (73.9, 0.0, −a+26.1),
point F (0.0102a²−2.2922a+59.604, 0.0, −0.0102a²+1.2922a+40.396), and
point E (0.0208a²−2.0723a+47.748, −0.0208a²+1.0723a+52.252, 0.0),
or on the straight lines AB and FE (excluding the points A, B, F, and E).

When the refrigerant according to the present disclosure further comprises R1234yf, the refrigerant preferably satisfies the following requirements. In this case, the refrigerant according to the present disclosure has a GWP of 500 or less and a condensation temperature glide of 5° C. or less.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 5.0≥x≥1.5, coordinates (x,y,z) in a ternary composition diagram in which the sum of R32, R1234yf, and R1234ze is (100−a) mass % are within the range of a figure surrounded by straight lines AB, BH, HG, and GA that connect the following four points:
point A (74.0, −a+26.0, 0.0),
point B (73.9, 0.0, −a+26.1),
point H (−0.1143a²+2.3143a+62.686, 0.0, 0.1143a²−3.3143a+37.314), and
point G (−0.0505a²+2.6396a+34.049, 0.0505a²−3.6396a+65.951, 0.0),
or on the straight lines AB and HG (excluding the points A, B, H, and G);
if 7.5≥x≥5.0, coordinates (x,y,z) in the ternary composition diagram are within the range of a figure surrounded by straight lines AB, BH, HG, and GA that connect the following four points:
point A (74.0, −a+26.0, 0.0),
point B (73.9, 0.0, −a+26.1),
point H (−0.072a²+1.9a+63.7, 0.0, 0.072a²−2.9a+36.3), and
point G (−0.0505a=+2.6396a+34.049, 0.0505a²−3.6396a+65.951, 0.0),
or on the straight lines AB and HG (excluding the points A, B, H, and G); or
if 10.0≥x>7.5, coordinates (x,y,z) in the ternary composition diagram are within the range of a figure surrounded by straight lines AR, RG, and GA that connect the following three points:
point A (74.0, −a+26.0, 0.0),
point R (73.9, 1.12a−8.4, −2.12a+34.5), and
point G (−0.0505a²+2.6396a+34.049, 0.0505a²−3.6396a+65.951, 0.0),
or on the straight lines AR and RG (excluding the points A and G).

When the refrigerant according to the present disclosure further comprises R1234yf, the refrigerant preferably satisfies the following requirements. In this case, the refrigerant according to the present disclosure has a GWP of 400 or less and a refrigerating capacity ratio of 70% or more relative to that of R410A.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines A′B′, B′D, DC, and CA′ that connect the following four points:
point A′ (59.0, −a+41.0, 0),
point B′ (58.9, 0.0, −a+41.1),
point D (0.0098a²−2.1856a+39.064, 0.0, −0.0098a²+1.1856a+60.936), and point C (0.0138a=−1.6252a+26.785, −0.0138a=+0.6252a+73.215, 0.0),
or on the straight lines A′B′ and DC (excluding the points A′, B′, D, and C).

When the refrigerant according to the present disclosure further comprises R1234yf, the refrigerant preferably satisfies the following requirements. In this case, the refrigerant according to the present disclosure has a GWP of 400 or less and a refrigerating capacity ratio of 85% or more relative to that of R410A.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines A′B′, B′F, FE, and EA′ that connect the following four points:
point A′ (59.0, −a+41.0, 0.0),
point B′ (58.9, 0.0, −a+41.1),
point F (0.0102a²−2.2922a+59.604, 0.0, −0.0102a²+1.2922a+40.396), and
point E (0.0208a=−2.0723a+47.748, −0.0208a²+1.0723a+52.252, 0.0),
or on the straight lines A′B′ and FE (excluding the points A′, B′, F, and E).

When the refrigerant according to the present disclosure further comprises R1234yf, the refrigerant preferably satisfies the following requirements. In this case, the refrigerant according to the present disclosure has a GWP of 400 or less and a condensation temperature glide of 5° C. or less.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 5.0≥x≥1.5, coordinates (x,y,z) in a ternary composition diagram in which the sum of R32, R1234yf, and R1234ze is (100−a) mass % are within the range of a figure surrounded by straight lines A′P, PG, and GA′ that connect the following three points:
point A′ (59.0, −a+41.0, 0.0),
point P (−0.019a²+0.1524a+58.714, −0.2571a²+4.1571a+9.5429, 0.2761a²−5.3095a+31.7431), and
point G (−0.0505a²+2.6396a+34.049, 0.0505a²−3.6396a+65.951, 0.0),
or on the straight lines A′P and PG (excluding the points A′ and G); or
if 10.0≥x≥5, coordinates (x,y,z) in the ternary composition diagram are within the range of a figure surrounded by straight lines A′P, PG, and GA′ that connect the following three points:
point A′ (59.0, −a+41.0, 0.0),
point P (59.0, −0.136a²+2.94a+12.6, 0.136a=−3.94a+28.4), and
point G (−0.0505a²+2.6396a+34.049, 0.0505a²−3.6396a+65.951, 0.0),
or on the straight lines A′P and PG (excluding the points A′ and G).

The refrigerants described above can be preferably used as working fluids in a refrigerating machine and are particularly suitable as alternative refrigerants for R410A.

The refrigerants described below can be preferably used as working fluids in a refrigerating machine and are particularly suitable as alternative refrigerants for R404A.

The refrigerant according to the present disclosure also preferably satisfies the following requirements. In this case, the refrigerant according to the present disclosure has a GWP of 150 or less, a condensation temperature glide of 5° C. or less, and a refrigerating capacity ratio of 70% or more relative to that of R404A.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines ST, TM, and MS that connect the following three points:
point S (10.0, 21.5, 68.5),
point T (1.9, 21.5, 76.6), and
point M (10.0, 12.5, 77.5),
or on the straight lines.

The refrigerant according to the present disclosure also preferably satisfies the following requirements. In this case, the refrigerant according to the present disclosure has a GWP of 150 or less and a refrigerating capacity ratio of 70% or more relative to that of R404A

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 1.9≥x≥1.5, coordinates (x,y,z) in a ternary composition diagram in which the sum of R32, R1234yf, and R1234ze is (100−a) mass % are within the range of a figure surrounded by straight lines A″T, TM, and MA″ that connect the following three points:
point A″ (21.8, −a+78.2, 0.0),
point T (21.5, −15.0a+28.5, 14.0a+50.0), and
point M (0.0035a²−0.9809a+10.358, −0.0035a²−0.0191a+89.642, 0.0),
or on the straight lines A″T and TM (excluding the points A″ and M); or
if 10.0≥x>1.9, coordinates (x,y,z) in the ternary composition diagram are within the range of a figure surrounded by straight lines A″B″, B″L, LM, and MA″ that connect the following four points:
point A″ (21.8, −a+78.2, 0.0),
point B″ (0.0108a+21.473, 0.0, −1.0108a+78.527),
point L (0.0098a=−1.2237a+23.804, 0.0, −0.0098a²+0.2237a+76.196), and
point M (0.0035a²−0.9809a+10.358, −0.0035a²−0.0191a+89.642, 0.0),
or on the straight lines A″B″ and LM (excluding the points A″, B″, L, and M).

### 1.2 Additional Refrigerant Components

Additional refrigerants that may be contained in the refrigerant according to the present disclosure are described below. The refrigerant according to the present disclosure may further comprise other additional refrigerants in addition to HFO-1132a, R32, and R1234ze as long as the above properties and effects are not impaired. In this respect, in an embodiment, the refrigerant according to the present disclosure preferably comprises HFO-1132a, R32, and R1234ze in a total amount of 99.5 mass % or more, more preferably 99.75 mass % or more, even more preferably 99.9 mass % or more, still even more preferably 99.99 mass % or more, and most preferably 99.9999 mass % or more, based on the entire refrigerant. The refrigerant according to the present disclosure may consist essentially of HFO-1132a, R32, and R1234ze or may consist of HFO-1132a, R32, and R1234ze. When the refrigerant according to the present disclosure consists essentially of HFO-1132a, R32, and R1234ze, the refrigerant according to the present disclosure may consist of HFO-1132a, R32, R1234ze, and inevitable impurities. In another embodiments, the refrigerant according to the present disclosure may further comprise other additional refrigerants in addition to HFO-1132a, R32, R1234ze, and R1234yf as long as the above properties and effects are not impaired. The refrigerant according to the present disclosure preferably comprises HFO-1132a, R32, R1234ze, and R1234yf in a total amount of 99.5 mass % or more, more preferably 99.75 mass % or more, even more preferably 99.9 mass % or more, still even more preferably 99.99 mass % or more, and most preferably 99.9999 mass % or more, based on the entire refrigerant. The refrigerant according to the present disclosure may consist essentially of HFO-1132a, R32, R1234ze, and R1234yf or may consist of HFO-1132a, R32, R1234ze, and R1234yf. When the refrigerant according to the present disclosure consists essentially of HFO-1132a, R32, R1234ze, and R1234yf, the refrigerant according to the present disclosure may consist of HFO-1132a, R32, R1234ze, R1234yf, and inevitable impurities.

Such additional refrigerants are not limited, and can be selected from a wide range of refrigerants. The mixed refrigerant may contain a single additional refrigerant, or two or more additional refrigerants.

### 2. Refrigerant Composition

The refrigerant composition according to the present disclosure comprises at least the refrigerant according to the present disclosure, and can be used for the same use as the refrigerant according to the present disclosure. Moreover, the refrigerant composition according to the present disclosure can be further mixed with at least a refrigeration oil to thereby obtain a working fluid for a refrigerating machine.

The refrigerant composition according to the present disclosure further comprises at least one other component in addition to the refrigerant according to the present disclosure. The refrigerant composition according to the present disclosure may comprise at least one of the following other components, if necessary. As described above, when the refrigerant composition according to the present disclosure is used as a working fluid in a refrigerating machine, it is generally used as a mixture with at least a refrigeration oil. Therefore, it is preferable that the refrigerant composition according to the present disclosure does not substantially comprise a refrigeration oil. Specifically, in the refrigerant composition according to the present disclosure, the content of the refrigeration oil based on the entire refrigerant composition is preferably 0 to 1 mass %, and more preferably 0 to 0.1 mass %.

### 2.1 Water

The refrigerant composition according to the present disclosure may contain a small amount of water. The water content of the refrigerant composition is preferably 0.1 mass % or less based on the entire refrigerant. A small amount of water contained in the refrigerant composition stabilizes double bonds in the molecules of unsaturated fluorocarbon compounds that can be present in the refrigerant, and makes it less likely that the unsaturated fluorocarbon compounds will be oxidized, thus increasing the stability of the refrigerant composition.

2.2. Tracer A tracer is added to the refrigerant composition according to the present disclosure at a detectable concentration such that when the refrigerant composition has been diluted, contaminated, or undergone other changes, the tracer can trace the changes.

The refrigerant composition according to the present disclosure may comprise a single tracer, or two or more tracers.

The tracer is not limited, and can be suitably selected from commonly used tracers.

Examples of tracers include hydrofluorocarbons, hydrochlorofluorocarbons, chlorofluorocarbons, hydrochlorocarbons, fluorocarbons, deuterated hydrocarbons, deuterated hydrofluorocarbons, perfluorocarbons, fluoroethers, brominated compounds, iodinated compounds, alcohols, aldehydes, ketones, and nitrous oxide (N₂O). The tracer is particularly preferably a hydrofluorocarbon, a hydrochlorofluorocarbon, a chlorofluorocarbon, a hydrochlorocarbon, a fluorocarbon, or a fluoroether.

The following compounds are preferable as the tracer.
FC-14 (tetrafluoromethane, CF₄)
HCC-40 (chloromethane, CH₃Cl)
HFC-23 (trifluoromethane, CHF₃)
HFC-41 (fluoromethane, CH₃Cl)
HFC-125 (pentafluoroethane, CF₃CHF₂)
HFC-134a (1,1,1,2-tetrafluoroethane, CF₃CH₂F)
HFC-134 (1,1,2,2-tetrafluoroethane, CHF₂CHF₂)
HFC-143a (1,1,1-trifluoroethane, CF₃CH₃)
HFC-143 (1,1,2-trifluoroethane, CHF₂CH₂F)
HFC-152a (1,1-difluoroethane, CHF₂CH₃)
HFC-152 (1,2-difluoroethane, CH₂FCH₂F)
HFC-161 (fluoroethane, CH₃CH₂F)
HFC-245fa (1,1,1,3,3-pentafluoropropane, CF₃CH₂CHF₂)
HFC-236fa (1,1,1,3,3,3-hexafluoropropane, CF₃CH₂CF₃)
HFC-236ea (1,1,1,2,3,3-hexafluoropropane, CF₃CHFCHF₂)
HFC-227ea (1,1,1,2,3,3,3-heptafluoropropane, CF₃CHFCF₃)
HCFC-22 (chlorodifluoromethane, CHClF₂)
HCFC-31 (chlorofluoromethane, CH₃ClF)
CFC-1113 (chlorotrifluoroethylene, CF₂═CClF)
HFE-125 (trifluoromethyl-difluoromethyl ether, CF₃OCHF₂)
HFE-134a (trifluoromethyl-fluoromethyl ether, CF₃OCH₂F)
HFE-143a (trifluoromethyl-methyl ether, CF₃OCH₃)
HFE-227ea (trifluoromethyl-tetrafluoroethyl ether, CF₃OCHFCF₃)
HFE-236fa (trifluoromethyl-trifluoroethyl ether, CF₃OCH₂CF₃)

The refrigerant composition of the present disclosure may contain the tracer in a total amount of about 10 parts per million by weight (ppm) to about 1000 ppm based on the entire refrigerant composition. The refrigerant composition of the present disclosure may contain the tracer in a total amount of preferably about 30 ppm to about 500 ppm, and more preferably about 50 ppm to about 300 ppm, based on the entire refrigerant composition.

### 2.3. Ultraviolet Fluorescent Dye

The refrigerant composition according to the present disclosure may comprise a single ultraviolet fluorescent dye, or two or more ultraviolet fluorescent dyes.

The ultraviolet fluorescent dye is not limited, and can be suitably selected from commonly used ultraviolet fluorescent dyes.

Examples of ultraviolet fluorescent dyes include naphthalimide, coumarin, anthracene, phenanthrene, xanthene, thioxanthene, naphthoxanthene, fluorescein, and derivatives thereof. The ultraviolet fluorescent dye is particularly preferably either naphthalimide or coumarin, or both.

### 2.4. Stabilizer

The refrigerant composition according to the present disclosure may comprise a single stabilizer, or two or more stabilizers.

The stabilizer is not limited, and can be suitably selected from commonly used stabilizers.

Examples of stabilizers include nitro compounds, ethers, and amines.

Examples of nitro compounds include aliphatic nitro compounds, such as nitromethane and nitroethane; and aromatic nitro compounds, such as nitro benzene and nitro styrene.

Examples of ethers include 1,4-dioxane.

Examples of amines include 2,2,3,3,3-pentafluoropropylamine and diphenylamine.

Examples of stabilizers also include butylhydroxyxylene and benzotriazole.

The content of the stabilizer is not limited. Generally, the content of the stabilizer is preferably 0.01 to 5 mass %, and more preferably 0.05 to 2 mass %, based on the entire refrigerant.

### 2.5. Polymerization Inhibitor

The refrigerant composition according to the present disclosure may comprise a single polymerization inhibitor, or two or more polymerization inhibitors.

The polymerization inhibitor is not limited, and can be suitably selected from commonly used polymerization inhibitors.

Examples of polymerization inhibitors include 4-methoxy-1-naphthol, hydroquinone, hydroquinone methyl ether, dimethyl-t-butylphenol, 2,6-di-tert-butyl-p-cresol, and benzotriazole.

The content of the polymerization inhibitor is not limited. Generally, the content of the polymerization inhibitor is preferably 0.01 to 5 mass %, and more preferably 0.05 to 2 mass %, based on the entire refrigerant.

### 3. Refrigeration Oil-Containing Working Fluid

The refrigeration oil-containing working fluid according to the present disclosure comprises at least the refrigerant or refrigerant composition according to the present disclosure and a refrigeration oil, for use as a working fluid in a refrigerating machine. Specifically, the refrigeration oil-containing working fluid according to the present disclosure is obtained by mixing a refrigeration oil used in a compressor of a refrigerating machine with the refrigerant or the refrigerant composition. The refrigeration oil-containing working fluid generally comprises 10 to 50 mass % of refrigeration oil.

### 3.1. Refrigeration Oil

The composition according to the present disclosure may comprise a single refrigeration oil, or two or more refrigeration oils.

The refrigeration oil is not limited, and can be suitably selected from commonly used refrigeration oils. In this case, refrigeration oils that are superior in the action of increasing the miscibility with the mixture and the stability of the mixture, for example, can be suitably selected as necessary.

The base oil of the refrigeration oil is preferably, for example, at least one member selected from the group consisting of polyalkylene glycols (PAG), polyol esters (POE), and polyvinyl ethers (PVE).

The refrigeration oil may further contain additives in addition to the base oil. The additive may be at least one member selected from the group consisting of antioxidants, extreme-pressure agents, acid scavengers, oxygen scavengers, copper deactivators, rust inhibitors, oil agents, and antifoaming agents.

A refrigeration oil with a kinematic viscosity of 5 to 400 cSt at 40° C. is preferable from the standpoint of lubrication.

The refrigeration oil-containing working fluid according to the present disclosure may further optionally contain at least one additive. Examples of additives include compatibilizing agents described below.

### 3.2. Compatibilizing Agent

The refrigeration oil-containing working fluid according to the present disclosure may comprise a single compatibilizing agent, or two or more compatibilizing agents.

The compatibilizing agent is not limited, and can be suitably selected from commonly used compatibilizing agents.

Examples of compatibilizing agents include polyoxyalkylene glycol ethers, amides, nitriles, ketones, chlorocarbons, esters, lactones, aryl ethers, fluoroethers, and 1,1,1-trifluoroalkanes. The compatibilizing agent is particularly preferably a polyoxyalkylene glycol ether.

### 4. Method for Operating Refrigerating Machine

The method for operating a refrigerating machine according to the present disclosure is a method for operating a refrigerating machine using the refrigerant according to the present disclosure.

Specifically, the method for operating a refrigerating machine according to the present disclosure comprises the step of circulating the refrigerant according to the present disclosure in a refrigerating machine.

The embodiments are described above; however, it will be understood that various changes in forms and details can be made without departing from the spirit and scope of the claims.

Item 1.

A composition comprising a refrigerant, the refrigerant comprising 1,1-difluoroethylene (HFO-1132a), difluoromethane (R32), and 1,3,3,3-tetrafluoropropene (R1234ze).

Item 2.

The composition according to Item 1, wherein the refrigerant comprises HFO-1132a in an amount of 1.5 to 10 mass % based on the entire refrigerant.

Item 3.

The composition according to Item 1, wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines IB, BC, CD, and DI that connect the following four points:
point I (10.0, 74.0, 16.0),
point B (1.5, 73.9, 24.6),
point C (1.5, 35.8, 62.7), and
point D (10.0, 18.2, 71.8),
or on the straight lines.

Item 4.

The composition according to Item 1, wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines IB, BE, EF, and FI that connect the following four points:
point I (10.0, 74.0, 16.0),
point B (1.5, 73.9, 24.6),
point E (1.5, 56.2, 42.3), and
point F (10.0, 37.7, 52.3),
or on the straight lines.

Item 5.

The composition according to Item 1, wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines G′B, BG, and GG′ that connect the following three points:
point G′ (8.6, 73.9, 17.5),
point B (1.5, 73.9, 24.6), and
point G (1.5, 65.9, 32.6),
or on the straight lines.

Item 6.

The composition according to Item 1, wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines JB′, B′C, CD, and DJ that connect the following four points:
point J (10.0, 59.0, 31.0),
point B′ (1.5, 58.9, 39.6),
point C (1.5, 35.8, 62.7), and
point D (10.0, 18.2, 71.8),
or on the straight lines.

Item 7.

The composition according to Item 1, wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines JB′, B′E, EF, and FJ that connect the following four points:
point J (10.0, 59.0, 31.0),
point B′ (1.5, 58.9, 39.6),
point E (1.5, 56.2, 42.3), and
point F (10.0, 37.7, 52.3),
or on the straight lines.

Item 8.

The composition according to any one of Items 1 to 7, wherein the refrigerant further comprises 2,3,3,3-tetrafluoro-1-propene (R1234yf).

Item 9.

The composition according to Item 8, wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines AB, BC, CD, and DA that connect the following four points:
point A (74.0, −a+26.0, 0.0),
point B (73.9, 0.0, −a+26.1),
point D (0.0098a²−2.1856a+39.064, 0.0, −0.0098a²+1.1856a+60.936), and
point C (0.0138a²−1.6252a+26.785, −0.0138a²+0.6252a+73.215, 0.0),
or on the straight lines AB and CD (excluding the points A, B, C, and D).

Item 10.

The composition according to Item 8, wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines AB, BF, FE, and EA that connect the following four points:
point A (74.0, −a+26.0, 0.0),
point B (73.9, 0.0, −a+26.1),
point F (0.0102a=−2.2922a+59.604, 0.0, −0.0102a²+1.2922a+40.396), and
point E (0.0208a²−2.0723a+47.748, −0.0208a²+1.0723a+52.252, 0.0),
or on the straight lines AB and FE (excluding the points A, B, F, and E).

Item 11.

The composition according to Item 8, wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 5.0≥x≥1.5, coordinates (x,y,z) in a ternary composition diagram in which the sum of R32, R1234yf, and R1234ze is (100−a) mass % are within the range of a figure surrounded by straight lines AB, BH, HG, and GA that connect the following four points:
point A (74.0, −a+26.0, 0.0),
point B (73.9, 0.0, −a+26.1),
point H (−0.1143a²+2.3143a+62.686, 0.0, 0.1143a²−3.3143a+37.314), and
point G (−0.0505a²+2.6396a+34.049, 0.0505a²−3.6396a+65.951, 0.0),
or on the straight lines AB and HG (excluding the points A, B, H, and G);
if 7.5≥x≥5.0, coordinates (x,y,z) in the ternary composition diagram are within the range of a figure surrounded by straight lines AB, BH, HG, and GA that connect the following four points:
point A (74.0, −a+26.0, 0.0),
point B (73.9, 0.0, −a+26.1),
point H (−0.072a²+1.9a+63.7, 0.0, 0.072a²−2.9a+36.3), and
point G (−0.0505a²+2.6396a+34.049, 0.0505a²−3.6396a+65.951, 0.0),
or on the straight lines AB and HG (excluding the points A, B, H, and G); or
if 10.0≥x≥7.5, coordinates (x,y,z) in the ternary composition diagram are within the range of a figure surrounded by straight lines AR, RG, and GA that connect the following three points:
point A (74.0, −a+26.0, 0.0),
point R (73.9, 1.12a−8.4, −2.12a+34.5), and
point G (−0.0505a²+2.6396a+34.049, 0.0505a²−3.6396a+65.951, 0.0),
or on the straight lines AR and RG (excluding the points A and G).

Item 12.

The composition according to Item 8, wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines A′B′, B′D, DC, and CA′ that connect the following four points:
point A′ (59.0, −a+41.0, 0),
point B′ (58.9, 0.0, −a+41.1),
point D (0.0098a²−2.1856a+39.064, 0.0, −0.0098a²+1.1856a+60.936), and
point C (0.0138a²−1.6252a+26.785, −0.0138a²+0.6252a+73.215, 0.0),
or on the straight lines A′B′ and DC (excluding the points A′, B′, D, and C).

Item 13.

The composition according to Item 8, wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines A′B′, B′F, FE, and EA′ that connect the following four points:
point A′ (59.0, −a+41.0, 0.0),
point B′ (58.9, 0.0, −a+41.1),
point F (0.0102a²−2.2922a+59.604, 0.0, −0.0102a²+1.2922a+40.396), and
point E (0.0208a²−2.0723a+47.748, −0.0208a=+1.0723a+52.252, 0.0),
or on the straight lines A′B′ and FE (excluding the points A′, B′, F, and E).

Item 14.

The composition according to Item 8, wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 5.0≥x≥1.5, coordinates (x,y,z) in a ternary composition diagram in which the sum of R32, R1234yf, and R1234ze is (100−a) mass % are within the range of a figure surrounded by straight lines A′P, PG, and GA′ that connect the following three points:
point A′ (59.0, −a+41.0, 0.0),
point P (−0.019a²+0.1524a+58.714, −0.2571a²+4.1571a+9.5429, 0.2761a²−5.3095a+31.7431), and
point G (−0.0505a²+2.6396a+34.049, 0.0505a²−3.6396a+65.951, 0.0),
or on the straight lines A′P and PG (excluding the points A′ and G); or
if 10.0≥x≥5, coordinates (x,y,z) in the ternary composition diagram are within the range of a figure surrounded by straight lines A′P, PG, and GA′ that connect the following three points:
point A′ (59.0, −a+41.0, 0.0),
point P (59.0, −0.136a²+2.94a+12.6, 0.136a²−3.94a+28.4), and
point G (−0.0505a²+2.6396a+34.049, 0.0505a=−3.6396a+65.951, 0.0),
or on the straight lines A′P and PG (excluding the points A′ and G).

Item 15.

The composition according to any one of Items 1 to 14, which is for use as an alternative refrigerant for R410A.

Item 16.

The composition according to Item 2, wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines ST, TM, and MS that connect the following three points:
point S (10.0, 21.5, 68.5),
point T (1.9, 21.5, 76.6), and
point M (10.0, 12.5, 77.5),
or on the straight lines.

Item 17.

The composition according to Item 8, wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 1.9≥x≥1.5, coordinates (x,y,z) in a ternary composition diagram in which the sum of R32, R1234yf, and R1234ze is (100−a) mass % are within the range of a figure surrounded by straight lines A″T, TM, and MA″ that connect the following three points:
point A″ (21.8, −a+78.2, 0.0),
point T (21.5, −15.0a+28.5, 14.0a+50.0), and
point M (0.0035a²−0.9809a+10.358, −0.0035a²−0.0191a+89.642, 0.0),
or on the straight lines A″T and TM (excluding the points A″ and M); or
if 10.0≥x>1.9, coordinates (x,y,z) in the ternary composition diagram are within the range of a figure surrounded by straight lines A″B″, B″L, LM, and MA″ that connect the following four points:
point A″ (21.8, −a+78.2, 0.0),
point B″ (0.0108a+21.473, 0.0, −1.0108a+78.527),
point L (0.0098a²−1.2237a+23.804, 0.0, −0.0098a²+0.2237a+76.196), and
point M (0.0035a²−0.9809a+10.358, −0.0035a²−0.0191a+89.642, 0.0),
or on the straight lines A″B″ and LM (excluding the points A″, B″, L, and M).

Item 18.

The composition according to Item 16 or 17, which is for use as an alternative refrigerant for R404A.

Item 19.

The composition according to any one of Items 1 to 18, which is for use as a working fluid for a refrigerating machine, the composition further comprising a refrigeration oil.

Item 20.

A refrigerating machine comprising the composition according to any one of Items 1 to 14, 16, 17, and 19 as a working fluid.

Item 21.

A method for operating a refrigerating machine, comprising circulating the composition according to any one of Items 1 to 14, 16, 17, and 19 as a working fluid in a refrigerating machine.

Item 22.

Use of the composition according to any one of Items 1 to 14 as an alternative refrigerant for R410A.

Item 23.

Use of the composition according to Item 16 or 17 as an alternative refrigerant for R404A.

### EXAMPLES

The present disclosure is described in more detail below with reference to Examples. However, the present disclosure is not limited to the Examples.

Mixed refrigerants were prepared by mixing HFO-1132a, R32, and R1234ze at the mass % shown in Table 1 based on their sum.

The GWPs of R410A (R32=50%/R125=50%) and the above mixed refrigerants were evaluated based on the values stated in the Intergovernmental Panel on Climate Change (IPCC), fourth report. The GWP of HFO-1132a was assumed to be 1. The refrigerating capacities of R410A and the above mixed refrigerants were determined by performing theoretical refrigeration cycle calculations for the mixed refrigerants by using the National Institute of Science and Technology (NIST) Reference Fluid Thermodynamic and Transport Properties Database (Refprop 9.0) under the following conditions.

For each of these mixed refrigerants, the COP ratio and refrigerating capacity ratio relative to those of R410A were determined. The calculation conditions were as follows:
Evaporating temperature: 5° C.
Condensation temperature: 45° C.
Superheating temperature: 5 K
Subcooling temperature: 5 K
Compressor efficiency: 70%

Table 1 shows these values together with the GWP of each mixed refrigerant. The COP and refrigerating capacity are ratios relative to R410A.

The coefficient of performance (COP) was determined according to the following formula.

COP=(refrigerating capacity or heating capacity)/power consumption

TABLE 1

| | | Comp. | Comp. | Comp. | | | | | | Comp. | Comp. |
|---|---|---|---|---|---|---|---|---|---|---|---|
| Item | Unit | Ex. 1 | Ex. 2 | Ex. 3 | Ex. 1 | Ex. 2 | Ex. 3 | Ex. 4 | Ex. 5 | Ex. 4 | Ex. 5 |
| HFO-1132a | mass % | R410A | 0.0 | 0.75 | 1.5 | 3.0 | 5.0 | 7.5 | 10.0 | 12.5 | 15.0 |
| R32 | mass % | | 50.0 | 50.0 | 50.0 | 50.0 | 50.0 | 50.0 | 50.0 | 50.0 | 50.0 |
| R1234ze | mass % | | 50.0 | 49.25 | 48.5 | 47.0 | 45.0 | 42.5 | 40.0 | 37.5 | 35.0 |
| GWP | — | 2088 | 341 | 340 | 340 | 340 | 340 | 340 | 340 | 340 | 340 |
| COP ratio | % (relative to | 100.0 | 104.7 | 104.4 | 104.0 | 103.4 | 102.5 | 101.6 | 100.7 | 99.8 | 98.9 |
| | R410A) | | | | | | | | | | |
| Refrigerating | % (relative to | 100.0 | 78.2 | 79.4 | 80.6 | 83.0 | 86.1 | 90.0 | 93.8 | 97.5 | 101.1 |
| capacity ratio | R410A) | | | | | | | | | | |
| Condensation | ° C. | 0 | 7.2 | 7.7 | 8.1 | 8.9 | 9.7 | 10.3 | 10.8 | 11.0 | 11.0 |
| temperature glide | | | | | | | | | | | |

| | | Comp. | | Comp. | | | | | |
|---|---|---|---|---|---|---|---|---|---|
| | | Ex. 6 | Ex. 6 | Ex. 7 | Ex. 7 | Ex. 8 | Ex. 9 | Ex. 10 | Ex. 11 |
| Item | Unit | A | B | A′ | B′ | C | D | E | F |
| HFO-1132a | mass % | 26.0 | 1.5 | 41.0 | 1.5 | 1.5 | 10.0 | 1.5 | 10.0 |
| R32 | mass % | 74.0 | 73.9 | 59.0 | 58.9 | 35.8 | 18.2 | 56.2 | 37.7 |
| R1234ze | mass % | 0.0 | 24.6 | 0.0 | 39.6 | 62.7 | 71.8 | 42.3 | 52.3 |
| GWP | — | 500 | 500 | 399 | 400 | 245 | 127 | 382 | 258 |
| COP ratio | % (relative to | 94.9 | 102.9 | 89.0 | 103.5 | 105.4 | 103.2 | 103.6 | 101.5 |
| | R410A) | | | | | | | | |
| Refrigerating | % (relative to | 131.0 | 97.0 | 139.0 | 86.9 | 70.0 | 70.0 | 85.0 | 85.0 |
| capacity ratio | R410A) | | | | | | | | |
| Condensation | ° C. | 4.6 | 3.6 | 3.9 | 6.3 | 11.0 | 21.4 | 6.9 | 14.5 |
| temperature glide | | | | | | | | | |

| | | | | Comp. | | |
|---|---|---|---|---|---|---|
| | | Ex. 12 | Ex. 13 | Ex. 8 | Ex. 14 | Ex. 15 |
| item | Unit | G | G′ | H | I | J |
| HFO-1132a | mass % | 1.5 | 8.6 | 10.0 | 10.0 | 10.0 |
| R32 | mass % | 65.9 | 73.9 | 75.5 | 74.0 | 59.0 |
| R1234ze | mass % | 32.6 | 17.5 | 14.5 | 16.0 | 31.0 |
| GWP | — | 447 | 500 | 511 | 501 | 400 |
| COP ratio | % (relative to | 103.1 | 100.5 | 100.0 | 100.1 | 100.4 |
| | R410A) | | | | | |
| Refrigerating | % (relative to | 91.7 | 107.7 | 110.7 | 109.8 | 100.1 |
| capacity ratio | R410A) | | | | | |
| Condensation | ° C. | 5.0 | 5.1 | 5.0 | 5.3 | 8.4 |
| temperature glide | | | | | | |

These results indicate that the mixed refrigerants have a GWP of 500 or less and a refrigerating capacity ratio of 70% or more relative to that of R410A when they satisfy the following requirements.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines IB, BC, CD, and DI that connect the following four points:
point I (10.0, 74.0, 16.0),
point B (1.5, 73.9, 24.6),
point C (1.5, 35.8, 62.7), and
point D (10.0, 18.2, 71.8),
or on the straight lines.

These results indicate that the mixed refrigerants have a GWP of 500 or less and a refrigerating capacity ratio of 85% or more relative to that of R410A when they satisfy the following requirements.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines IB, BE, EF, and FI that connect the following four points:
point I (10.0, 74.0, 16.0),
point B (1.5, 73.9, 24.6),
point E (1.5, 56.2, 42.3), and
point F (10.0, 37.7, 52.3),
or on the straight lines.

These results indicate that the mixed refrigerants have a GWP of 500 or less and a condensation temperature glide of 5° C. or less when they satisfy the following requirements.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines G′B, BG, and GG′ that connect the following three points:
point G′ (8.6, 73.9, 17.5),
point B (1.5, 73.9, 24.6), and
point G (1.5, 65.9, 32.6),
or on the straight lines.

These results indicate that the mixed refrigerants have a GWP of 400 or less and a refrigerating capacity ratio of 70% or more relative to that of R410A when they satisfy the following requirements.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines JB′, B′C, CD, and DJ that connect the following four points:
point J (10.0, 59.0, 31.0),
point B′ (1.5, 58.9, 39.6),
point C (1.5, 35.8, 62.7), and
point D (10.0, 18.2, 71.8),
or on the straight lines.

These results indicate that the mixed refrigerants have a GWP of 400 or less and a refrigerating capacity ratio of 85% or more relative to that of R410A when they satisfy the following requirements.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines JB′, B′E, EF, and FJ that connect the following four points:
point J (10.0, 59.0, 31.0),
point B′ (1.5, 58.9, 39.6),
point E (1.5, 56.2, 42.3), and
point F (10.0, 37.7, 52.3),
or on the straight lines.

Mixed refrigerants further comprising R1234yf in addition to HFO-1132a, R32, and R1234ze were evaluated in the same manner as described above. Tables 2 to 4 shows the results.

TABLE 2

| | | Comp. | Comp. | | | | | | Comp. | Comp. |
|---|---|---|---|---|---|---|---|---|---|---|
| Item | Unit | Ex. 9 | Ex. 10 | Ex. 16 | Ex. 17 | Ex. 18 | Ex. 19 | Ex. 20 | Ex. 11 | Ex. 12 |
| HFO-1132a | mass % | 0.0 | 0.75 | 1.5 | 3.0 | 5.0 | 7.5 | 10.0 | 12.5 | 15.0 |
| R32 | mass % | 65.0 | 65.0 | 65.0 | 65.0 | 65.0 | 65.0 | 65.0 | 65.0 | 65.0 |
| R1234yf | mass % | 20.0 | 20.0 | 20.0 | 20.0 | 20.0 | 20.0 | 20.0 | 20.0 | 20.0 |
| R1234ze | mass % | 15.0 | 14.25 | 13.5 | 12.0 | 10.0 | 7.5 | 5.0 | 2.5 | 0.0 |
| GWP | — | 440 | 440 | 440 | 440 | 440 | 440 | 440 | 440 | 440 |
| COP ratio | % (relative to | 102.9 | 102.7 | 102.4 | 101.9 | 101.2 | 100.4 | 99.6 | 98.8 | 97.9 |
| | R410A) | | | | | | | | | |
| Refrigerating | % (relative to | 92.4 | 93.6 | 94.7 | 97.0 | 100.0 | 103.7 | 107.3 | 110.8 | 114.2 |
| capacity ratio | R410A) | | | | | | | | | |
| Condensation | ° C. | 2.7 | 3.0 | 3.2 | 3.6 | 4.0 | 4.4 | 4.7 | 4.8 | 4.8 |
| temperature glide | | | | | | | | | | |
| | | Comp. | Comp. | | | | | | Comp. | Comp. |
| Item | Unit | Ex. 13 | Ex. 14 | Ex. 21 | Ex. 22 | Ex. 23 | Ex. 24 | Ex. 25 | Ex. 15 | Ex. 16 |
| HFO-11328 | mass % | 0.0 | 0.8 | 1.5 | 3.0 | 5.0 | 7.5 | 10.0 | 12.5 | 15.0 |
| R32 | mass % | 65.0 | 65.0 | 65.0 | 65.0 | 65.0 | 65.0 | 65.0 | 65.0 | 65.0 |
| R1234yf | mass % | 20.0 | 19.3 | 18.5 | 17.0 | 15.0 | 12.5 | 10.0 | 7.5 | 5.0 |
| R1234ze | mass % | 15.0 | 15.00 | 15.0 | 15.0 | 15.0 | 15.0 | 15.0 | 15.0 | 15.0 |
| GWP | — | 440 | 440 | 440 | 440 | 440 | 440 | 440 | 440 | 440 |
| COP ratio | % (relative to | 102.9 | 102.7 | 102.4 | 102.0 | 101.4 | 100.6 | 99.9 | 99.2 | 98.5 |
| | R410A) | | | | | | | | | |
| Refrigerating | % (relative to | 92.4 | 93.4 | 94.5 | 96.5 | 99.2 | 102.5 | 105.7 | 108.9 | 112.1 |
| capacity ratio | R410A) | | | | | | | | | |
| Condensation | ° C. | 2.7 | 3.0 | 3.3 | 3.9 | 4.6 | 5.2 | 5.8 | 6.2 | 6.5 |
| temperature glide | | | | | | | | | | |
| | | Comp. | Comp. | | | | | | Comp. | Comp. |
| Item | Unit | Ex. 17 | Ex. 18 | Ex. 26 | Ex. 27 | Ex. 28 | Ex. 29 | Ex. 30 | Ex. 19 | Ex. 20 |
| HFO-1132a | mass % | 0.0 | 0.75 | 1.5 | 3.0 | 5.0 | 7.5 | 10.0 | 10.0 | 15.0 |
| R32 | mass % | 65.0 | 64.3 | 63.5 | 62.0 | 60.0 | 57.5 | 55.0 | 52.5 | 50.0 |
| R1234yf | mass % | 20.0 | 20.0 | 20.0 | 20.0 | 20.0 | 20.0 | 20.0 | 20.0 | 20.0 |
| R1234ze | mass % | 15.0 | 15.00 | 15.0 | 15.0 | 15.0 | 15.0 | 15.0 | 15.0 | 15.0 |
| GWP | — | 440 | 435 | 430 | 420 | 407 | 390 | 373 | 356 | 339 |
| COP ratio | % (relative to | 102.9 | 102.7 | 102.4 | 101.9 | 101.3 | 100.5 | 99.8 | 99.7 | 98.2 |
| | R410A) | | | | | | | | | |
| Refrigerating | % (relative to | 92.4 | 93.1 | 93.7 | 94.9 | 96.6 | 98.5 | 100.4 | 100.0 | 104.0 |
| capacity ratio | R410A) | | | | | | | | | |
| Condensation | ° C. | 2.7 | 3.1 | 3.4 | 4.1 | 5.0 | 5.9 | 6.7 | 7.0 | 8.0 |
| temperature glide | | | | | | | | | | |

TABLE 3

| | | Comp. | Comp. | Comp. | Comp. | Comp. | Comp. | Comp. | Comp. |
|---|---|---|---|---|---|---|---|---|---|
| | | Ex. 21 | Ex. 22 | Ex. 23 | Ex. 24 | Ex. 25 | Ex. 26 | Ex. 27 | Ex. 28 |
| Item | Unit | A | B | A′ | B′ | C | D | E | F |
| HFO-11328 | mass % | 1.9 | 1.5 | 1.5 | 1.5 | 3.5 | 1.5 | 1.5 | 1.5 |
| R32 | mass % | 74.0 | 73.9 | 59.0 | 58.9 | 24.4 | 35.8 | 44.7 | 56.2 |
| R1234yf | mass % | 24.5 | 0.0 | 39.5 | 0.0 | 74.1 | 0.0 | 53.8 | 0.0 |
| R1234ze | mass % | 0.0 | 24.6 | 0.0 | 39.6 | 0.0 | 62.7 | 0.0 | 42.3 |
| GWP | — | 500 | 500 | 400 | 400 | 168 | 245 | 304 | 382 |
| COP ratio | % (relative to | 101.9 | 102.9 | 101.8 | 103.5 | 102.6 | 105.4 | 101.7 | 103.6 |
| | R410A) | | | | | | | | |
| Refrigerating | % (relative to | 101.4 | 97.0 | 93.7 | 85.9 | 70.0 | 70.0 | 85.0 | 85.0 |
| capacity ratio | R410A) | | | | | | | | |
| Condensation | ° C. | 1.5 | 3.6 | 2.5 | 6.3 | 7.1 | 11.0 | 4.0 | 6.9 |
| temperature glide | | | | | | | | | |

| | | Comp. | | Comp. | Comp. | Comp. | Comp. |
|---|---|---|---|---|---|---|---|
| | | Ex. 29 | Ex. 31 | Ex. 30 | Ex. 31 | Ex. 32 | Ex. 33 |
| Item | Unit | G | P | H | C′ | E′ | G′ |
| HFO-1132a | mass % | 1.5 | 1.5 | 1.5 | 1.5 | 1.5 | 1.5 |
| R32 | mass % | 37.9 | 58.9 | 65.9 | 30.1 | 50.4 | 51.9 |
| R1234yf | mass % | 60.6 | 15.2 | 0.0 | 32.6 | 24.9 | 26.2 |
| R1234ze | mass % | 0.0 | 24.4 | 32.6 | 35.8 | 23.2 | 20.4 |
| GWP | — | 258 | 400 | 447 | 207 | 343 | 353 |
| COP ratio | % (relative to | 101.8 | 102.8 | 103.1 | 104.1 | 102.8 | 102.6 |
| | R410A) | | | | | | |
| Refrigerating | % (relative to | 80.3 | 89.6 | 91.7 | 70.0 | 85.0 | 86.4 |
| capacity ratio | R410A) | | | | | | |
| Condensation | ° C. | 5.0 | 4.7 | 5.0 | 9.0 | 5.4 | 5.0 |
| temperature glide | | | | | | | |

| | | Comp. | Comp. | Comp. | Comp. | Comp. | Comp. | Comp. | Comp. |
|---|---|---|---|---|---|---|---|---|---|
| | | Ex. 34 | Ex. 35 | Ex. 36 | Ex. 37 | Ex. 38 | Ex. 39 | Ex. 40 | Ex. 41 |
| Item | Unit | A | B | A′ | B′ | C | D | E | F |
| HFO-1132a | mass % | 3.0 | 3.0 | 3.0 | 3.0 | 3.0 | 3.0 | 3.0 | 3.0 |
| R32 | mass % | 74.0 | 73.9 | 59.0 | 58.9 | 22.0 | 32.6 | 41.7 | 52.8 |
| R1234yf | mass % | 23.0 | 0.0 | 38.0 | 0.0 | 75.0 | 0.0 | 55.3 | 0.0 |
| R1234ze | mass % | 0.0 | 23.1 | 0.0 | 38.1 | 0.0 | 64.4 | 0.0 | 44.2 |
| GWP | — | 500 | 500 | 400 | 400 | 152 | 224 | 284 | 359 |
| COP ratio | % (relative to | 101.5 | 102.3 | 101.3 | 102.8 | 102.4 | 104.9 | 101.3 | 103.2 |
| | R410A) | | | | | | | | |
| Refrigerating | % (relative to | 103.3 | 99.3 | 95.7 | 89.3 | 70.0 | 70.0 | 85.0 | 85.0 |
| capacity ratio | R410A) | | | | | | | | |
| Condensation | ° C. | 2.0 | 4.1 | 3.0 | 6.9 | 8.1 | 12.9 | 5.0 | 8.2 |
| temperature glide | | | | | | | | | |
| | | Comp. | | Comp. | Comp. | Comp. | Comp. | Comp. | Comp. |
| | | Ex. 42 | Ex. 32 | Ex. 43 | Ex. 44 | Ex. 45 | Ex. 46 | Ex. 47 | Ex. 48 |
| Item | Unit | G | P | H | A | B | A′ | B′ | C |
| HFO-11328 | mass % | 3.0 | 3.0 | 3.0 | 5.0 | .0 | 5.0 | 5.0 | 5.0 |
| R32 | mass % | 41.5 | 59.0 | 68.6 | 74.0 | 73.9 | 59.0 | 58.9 | 19.0 |
| R1234yf | mass % | 55.5 | 19.7 | 0.0 | 21.0 | 0.0 | 36.0 | 0.0 | 76.0 |
| R1234ze | mass % | 0.0 | 18.3 | 28.4 | 0.0 | 21.0 | 0.0 | 36.1 | 0.0 |
| GWP | — | 282 | 400 | 466 | 500 | 500 | 400 | 400 | 131 |
| COP ratio | % (relative to | 101.3 | 102.1 | 102.5 | 100.9 | 101.7 | 100.7 | 102.1 | 102.1 |
| | R410A) | | | | | | | | |
| Refrigerating | % (relative to | 84.8 | 92.8 | 95.9 | 105.9 | 102.4 | 98.4 | 92.4 | 70.0 |
| capacity ratio | R410A) | | | | | | | | |
| Condensation | ° C. | 5.0 | 4.7 | 5.0 | 2.5 | 4.6 | 3.6 | 7.5 | 9.5 |
| temperature glide | | | | | | | | | |

| | | Comp. | Comp. | Comp. | Comp. | | Comp. |
|---|---|---|---|---|---|---|---|
| | | Ex. 49 | Ex. 50 | Ex. 51 | Ex. 52 | Ex. 33 | Ex. 53 |
| Item | Unit | D | E | F | G | P | H |
| HFO-1132a | mass % | 5.0 | 5.0 | 5.0 | 5.0 | 5.0 | 5.0 |
| R32 | mass % | 28.4 | 37.9 | 48.4 | 46.0 | 59.0 | 73.4 |
| R1234yf | mass % | 0.0 | 57.1 | 0.0 | 49.0 | 23.9 | 0.0 |
| R1234ze | mass % | 66.6 | 0.0 | 46.6 | 0.0 | 12.1 | 23.6 |
| GWP | — | 196 | 258 | 330 | 313 | 400 | 483 |
| COP ratio | % (relative to | 104.3 | 100.7 | 102.6 | 100.6 | 101.2 | 101.7 |
| | R410A) | | | | | | |
| Refrigerating | % (relative to | 70.0 | 85.0 | 85.0 | 90.5 | 96.5 | 100.8 |
| capacity ratio | R410A | | | | | | |
| Condensation | ° C. | 15.3 | 6.2 | 10.1 | 5.6 | 4.8 | 5.0 |
| temperature glide | | | | | | | |

TABLE 4

| | | Comp. | Comp. | Comp. | Comp. | Comp. | Comp. | Comp. | Comp. |
|---|---|---|---|---|---|---|---|---|---|
| | | Ex. 54 | Ex. 55 | Ex. 56 | Ex. 57 | Ex. 58 | Ex. 59 | Ex. 60 | Ex. 61 |
| Item | Unit | A | B = H | A′ | B′ | C | D | E | F |
| HFO-1132a | mass % | 7.5 | 7.5 | 7.5 | 7.5 | 7.5 | 7.5 | 7.5 | 7.5 |
| R32 | mass % | 74.0 | 73.9 | 59.0 | 58.9 | 15.4 | 23.2 | 33.4 | 43.0 |
| R1234yf | mass % | 18.5 | 0.0 | 33.5 | 0.0 | 77.1 | 0.0 | 59.1 | 0.0 |
| R1234ze | mass % | 0.0 | 18.6 | 0.0 | 33.6 | 0.0 | 69.3 | 0.0 | 49.5 |
| GWP | — | 500 | 500 | 400 | 400 | 107 | 161 | 228 | 293 |
| COP ratio | % (relative to | 100.2 | 100.8 | 100.0 | 101.2 | 101.8 | 103.7 | 100.2 | 102.0 |
| | R410A) | | | | | | | | |
| Refrigerating | % (relative to | 109.1 | 106.1 | 101.6 | 96.2 | 70.0 | 70.0 | 85.0 | 85.0 |
| capacity ratio | R410A) | | | | | | | | |
| Condensation | ° C. | 3.1 | 5.0 | 4.2 | 8.1 | 11.1 | 18.4 | 7.7 | 12.3 |
| temperature glide | | | | | | | | | |
| | | Comp. | | Comp. | Comp. | Comp. | Comp. | Comp. | Comp. |
| | | Ex. 62 | Ex. 34 | Ex. 63 | Ex. 64 | Ex. 65 | Ex. 66 | Ex. 67 | Ex. 68 |
| Item | Unit | G | P | A | B | A′ | B′ | C | D |
| HFO-1132a | mass % | 7.5 | 7.5 | 10.0 | 10.0 | 10.0 | 10.0 | 10.0 | 10.0 |
| R32 | mass % | 51.0 | 59.0 | 74.0 | 73.9 | 59.0 | 58.9 | 11.9 | 18.2 |
| R1234yf | mass % | 41.5 | 27.0 | 16.0 | 0.0 | 31.0 | 0.0 | 78.1 | 0.0 |
| R1234ze | mass % | 0.0 | 6.5 | 0.0 | 16.1 | 0.0 | 31.1 | 0.0 | 71.8 |
| GWP | — | 346 | 400 | 500 | 500 | 400 | 400 | 84 | 127 |
| COP ratio | % (relative to | 99.9 | 100.2 | 99.5 | 100.1 | 99.3 | 100.4 | 101.6 | 103.2 |
| | R410A) | | | | | | | | |
| Refrigerating | % (relative to | 97.0 | 100.7 | 112.3 | 109.7 | 104.8 | 100.0 | 70.0 | 70.0 |
| capacity ratio | R410A) | | | | | | | | |
| Condensation | ° C. | 5.0 | 4.8 | 3.6 | 5.3 | 4.6 | 8.4 | 12.5 | 21.4 |
| temperature glide | | | | | | | | | |

| | | Comp. | Comp. | Comp. | | Comp. | Comp. |
|---|---|---|---|---|---|---|---|
| | | Ex. 69 | Ex. 70 | Ex. 71 | Ex. 35 | Ex. 72 | Ex. 73 |
| Item | Unit | E | F | G | P | R | H |
| HFO-1132a | mass % | 10.0 | 10.0 | 10.0 | 10.0 | 10.0 | 10.0 |
| R32 | mass % | 29.1 | 37.7 | 55.4 | 59.0 | 73.9 | 75.5 |
| R1234yf | mass % | 60.9 | 0.0 | 34.6 | 28.4 | 2.8 | 0.0 |
| R1234ze | mass % | 0.0 | 52.3 | 0.0 | 2.6 | 13.3 | 14.5 |
| GWP | — | 199 | 258 | 375 | 400 | 500 | 511 |
| COP ratio | % (relative to | 99.7 | 101.5 | 99.2 | 99.4 | 100.0 | 100.0 |
| | R410A) | | | | | | |
| Refrigerating | % (relative to | 85.0 | 85.0 | 102.8 | 104.5 | 110.2 | 110.7 |
| capacity ratio | R410A) | | | | | | |
| Condensation | ° C. | 9.1 | 14.5 | 5.0 | 4.9 | 5.0 | 5.0 |
| temperature glide | | | | | | | |

These results indicate that the mixed refrigerants have a GWP of 500 or less and a refrigerating capacity ratio of 70% or more relative to that of R410A when they satisfy the following requirements.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines AB, BC, CD, and DA that connect the following four points:
point A (74.0, −a+26.0, 0.0),
point B (73.9, 0.0, −a+26.1),
point D (0.0098a²−2.1856a+39.064, 0.0, −0.0098a²+1.1856a+60.936), and
point C (0.0138a²−1.6252a+26.785, −0.0138a²+0.6252a+73.215, 0.0),
or on the straight lines AB and CD (excluding the points A, B, C, and D).

These results indicate that the mixed refrigerants have a GWP of 500 or less and a refrigerating capacity ratio of 85% or more relative to that of R410A when they satisfy the following requirements.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines AB, BF, FE, and EA that connect the following four points:
point A (74.0, −a+26.0, 0.0),
point B (73.9, 0.0, −a+26.1),
point F (0.0102a²−2.2922a+59.604, 0.0, −0.0102a²+1.2922a+40.396), and
point E (0.0208a²−2.0723a+47.748, −0.0208a²+1.0723a+52.252, 0.0),
or on the straight lines AB and FE (excluding the points A, B, F, and E).

These results indicate that the mixed refrigerants have a GWP of 500 or less and a condensation temperature glide of 5° C. or less when they satisfy the following requirements.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 5.0≥x≥1.5, coordinates (x,y,z) in a ternary composition diagram in which the sum of R32, R1234yf, and R1234ze is (100−a) mass % are within the range of a figure surrounded by straight lines AB, BH, HG, and GA that connect the following four points:
point A (74.0, −a+26.0, 0.0),
point B (73.9, 0.0, −a+26.1),
point H (−0.1143a²+2.3143a+62.686, 0.0, 0.1143a=−3.3143a+37.314), and
point G (−0.0505a²+2.6396a+34.049, 0.0505a²−3.6396a+65.951, 0.0),
or on the straight lines AB and HG (excluding the points A, B, H, and G);
if 7.5≥x>5.0, coordinates (x,y,z) in the ternary composition diagram are within the range of a figure surrounded by straight lines AB, BH, HG, and GA that connect the following four points:
point A (74.0, −a+26.0, 0.0),
point B (73.9, 0.0, −a+26.1),
point H (−0.072a²+1.9a+63.7, 0.0, 0.072a²−2.9a+36.3), and
point G (−0.0505a²+2.6396a+34.049, 0.0505a²−3.6396a+65.951, 0.0),
or on the straight lines AB and HG (excluding the points A, B, H, and G); or
if 10.0≥x≥7.5, coordinates (x,y,z) in the ternary composition diagram are within the range of a figure surrounded by straight lines AR, RG, and GA that connect the following three points:
point A (74.0, −a+26.0, 0.0),
point R (73.9, 1.12a−8.4, −2.12a+34.5), and
point G (−0.0505a²+2.6396a+34.049, 0.0505a²−3.6396a+65.951, 0.0),
or on the straight lines AR and RG (excluding the points A and G).

These results indicate that the mixed refrigerants have a GWP of 400 or less and a refrigerating capacity ratio of 70% or more relative to that of R410A when they satisfy the following requirements.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines A′B′, B′D, DC, and CA′ that connect the following four points:
point A′ (59.0, −a+41.0, 0),
point B′ (58.9, 0.0, −a+41.1),
point D (0.0098a=−2.1856a+39.064, 0.0, −0.0098a²+1.1856a+60.936), and
point C (0.0138a²−1.6252a+26.785, −0.0138a²+0.6252a+73.215, 0.0),
or on the straight lines A′B′ and DC (excluding the points A′, B′, D, and C).

These results indicate that the mixed refrigerants have a GWP of 400 or less and a refrigerating capacity ratio of 85% or more relative to that of R410A when they satisfy the following requirements.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines A′B′, B′F, FE, and EA′ that connect the following four points:
point A′ (59.0, −a+41.0, 0.0),
point B′ (58.9, 0.0, −a+41.1),
point F (0.0102a²−2.2922a+59.604, 0.0, −0.0102a²+1.2922a+40.396), and
point E (0.0208a²−2.0723a+47.748, −0.0208a²+1.0723a+52.252, 0.0),
or on the straight lines A′B′ and FE (excluding the points A′, B′, F, and E).

These results indicate that the mixed refrigerants have a GWP of 400 or less and a condensation temperature glide of 5° C. or less when they satisfy the following requirements.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 5.0≥x≥1.5, coordinates (x,y,z) in a ternary composition diagram in which the sum of R32, R1234yf, and R1234ze is (100−a) mass % are within the range of a figure surrounded by straight lines A′P, PG, and GA′ that connect the following three points:
point A′ (59.0, −a+41.0, 0.0),
point P (−0.019a²+0.1524a+58.714, −0.2571a²+4.1571a+9.5429, 0.2761a²−5.3095a+31.7431), and
point G (−0.0505a²+2.6396a+34.049, 0.0505a²−3.6396a+65.951, 0.0),
or on the straight lines A′P and PG (excluding the points A′ and G), or
if 10.0≥x≥5, coordinates (x,y,z) in the ternary composition diagram are within the range of a figure surrounded by straight lines A′P, PG, and GA′ that connect the following three points:
point A′ (59.0, −a+41.0, 0.0),
point P (59.0, −0.136a²+2.94a+12.6, 0.136a=−3.94a+28.4), and
point G (−0.0505a²+2.6396a+34.049, 0.0505a²−3.6396a+65.951, 0.0),
or on the straight lines A′P and PG (excluding the points A′ and G).

Approximate expressions indicating the coordinates of each point were obtained by determining approximate expressions for the curves connecting three points, as shown in Tables 5 and 6.

TABLE 5
Point A

| | | | | | | |
|---|---|---|---|---|---|---|
| a = HFO-1132a | mass % | 1.5 | 3.0 | 5.0 | 7.5 | 10.0 |
| R32 | mass % | 74.0 | 74.0 | 74.0 | 74.0 | 74.0 |
| R1234yf | mass % | 24.5 | 23.0 | 21.0 | 18.5 | 16.0 |
| R1234ze | mass % | 0.0 | 0.0 | 0.0 | 0.0 | 0.0 |

| | |
|---|---|
| R32 approximate expression | 74.0 |
| R1234yf approximate expression | −a + 26 |
| R1234ze approximate expression | 0.0 |

Point B

| | | | | | | |
|---|---|---|---|---|---|---|
| a = HFO-1132a | mass % | 1.5 | 3.0 | 5.0 | 7.5 | 10.0 |
| R32 | mass % | 73.9 | 73.9 | 73.9 | 73.9 | 73.9 |
| R1234yf | mass % | 0.0 | 0.0 | 0.0 | 0.0 | 0.0 |
| R1234ze | mass % | 24.6 | 23.1 | 21.1 | 18.6 | 16.1 |

| | |
|---|---|
| R32 approximate expression | 73.9 |
| R1234yf approximate expression | 0.0 |
| R1234ze approximate expression | −a + 26.1 |

Point A′

| | | | | | | |
|---|---|---|---|---|---|---|
| a = HFO-1132a | mass % | 1.5 | 3.0 | 5.0 | 7.5 | 10.0 |
| R32 | mass % | 59.0 | 59.0 | 59.0 | 59.0 | 59.0 |
| R1234yf | mass % | 39.5 | 38.0 | 36.0 | 33.5 | 31.0 |
| R1234ze | mass % | 0.0 | 0.0 | 0.0 | 0.0 | 0.0 |

| | |
|---|---|
| R32 approximate expression | 59.0 |
| R1234yf approximate expression | −a + 41.0 |
| R1234ze approximate expression | 0.0 |

Point B′

| | | | | | | |
|---|---|---|---|---|---|---|
| a = HFO-1132a | mass % | 1.5 | 3.0 | 5.0 | 7.5 | 10.0 |
| R32 | mass % | 58.9 | 58.9 | 58.9 | 58.9 | 58.9 |
| R1234yf | mass % | 0.0 | 0.0 | 0.0 | 0.0 | 0.0 |
| R1234ze | mass % | 39.6 | 38.1 | 36.1 | 33.6 | 31.1 |

| | |
|---|---|
| R32 approximate expression | 58.9 |
| R1234yf approximate expression | 0.0 |
| R1234ze approximate expression | −a + 41.1 |

Point C

| | | | | | | |
|---|---|---|---|---|---|---|
| a = HFO-1132a | mass % | 1.5 | 3.0 | 5.0 | 7.5 | 10.0 |
| R32 | mass % | 24.4 | 22.0 | 19.0 | 15.4 | 11.9 |
| R1234yf | mass % | 74.1 | 75.0 | 76.0 | 77.1 | 78.1 |
| R1234ze | mass % | 0.0 | 0.0 | 0.0 | 0.0 | 0.0 |

| | |
|---|---|
| R32 approximate expression | 0.0138a² − 1.6252a + 26.785 |
| R1234yf approximate expression | −0.0138a² + 0.6252a + 73.215 |
| R1234ze approximate expression | 0.0 |

Point D

| | | | | | | |
|---|---|---|---|---|---|---|
| a = HFO-1132a | mass % | 1.5 | 3.0 | 5.0 | 7.5 | 10.0 |
| R32 | mass % | 35.8 | 32.6 | 28.4 | 23.2 | 18.2 |
| R1234yf | mass % | 0.0 | 0.0 | 0.0 | 0.0 | 0.0 |
| R1234ze | mass % | 62.7 | 64.4 | 66.6 | 69.3 | 71.8 |

| | |
|---|---|
| R32 approximate expression | 0.0098a² − 2.1856a + 39.064 |
| R1234yf approximate expression | 0.0 |
| R1234ze approximate expression | −0.0098a² + 1.1856a + 60.936 |

TABLE 6
Point E

| | | | | | | |
|---|---|---|---|---|---|---|
| a = HFO-1132a | mass % | 1.5 | 3.0 | 5.0 | 7.5 | 10.0 |
| R32 | mass % | 44.7 | 41.7 | 37.9 | 33.4 | 29.1 |
| R1234yf | mass % | 53.8 | 55.3 | 57.1 | 59.1 | 60.9 |
| R1234ze | mass % | 0.0 | 0.0 | 0.0 | 0.0 | 0.0 |

| | |
|---|---|
| R32 approximate expression | 0.0208a² − 2.0723a + 47.748 |
| R1234yf approximate expression | −0.0208a² + 1.0723a + 52.252 |
| R1234ze approximate expression | 0.0 |

Point F

| | | | | | | |
|---|---|---|---|---|---|---|
| a = HFO-1132a | mass % | 1.5 | 3.0 | 5.0 | 7.5 | 10.0 |
| R32 | mass % | 56.2 | 52.8 | 48.4 | 43.0 | 37.7 |
| R1234yf | mass % | 0.0 | 0.0 | 0.0 | 0.0 | 0.0 |
| R1234ze | mass % | 42.3 | 44.2 | 46.6 | 49.5 | 52.3 |

| | |
|---|---|
| R32 approximate expression | 0.0102a² − 2.2922a + 59.604 |
| R1234yf approximate expression | 0.0 |
| R1234ze approximate expression | −0.0102a² + 1.2922a + 40.396 |

Point G

| | | | | | | |
|---|---|---|---|---|---|---|
| a = HFO-1132a | mass % | 1.5 | 3.0 | 5.0 | 7.5 | 10.0 |
| R32 | mass % | 37.9 | 41.5 | 46.0 | 51.0 | 55.4 |
| R1234yf | mass % | 60.6 | 55.5 | 49.0 | 41.5 | 34.6 |
| R1234ze | mass % | 0.0 | 0.0 | 0.0 | 0.0 | 0.0 |

| | |
|---|---|
| R32 approximate expression | −0.0505a² + 2.6396a + 34.049 |
| R1234yf approximate expression | 0.0505a² − 3.6396a + 65.951 |
| R1234ze approximate expression | 0.0 |

Point H

| | | | | | | | |
|---|---|---|---|---|---|---|---|
| a = HFO-1132a | mass % | 1.5 | 3.0 | 5.0 | 5.0 | 7.5 | 10.0 |
| R32 | mass % | 65.9 | 68.6 | 71.4 | 71.4 | 73.9 | 75.5 |
| R1234yf | mass % | 0.0 | 0.0 | 0.0 | 0.0 | 0.0 | 0.0 |
| R1234ze | mass % | 32.6 | 28.4 | 23.6 | 23.6 | 18.6 | 14.5 |

| | | |
|---|---|---|
| R32 approximate expression | −0.1143a² + 2.3143a + 62.686 | −0.072a² + 1.9a + 63.7 |
| R1234yf approximate expression | 0.0 | 0.0 |
| R1234ze approximate expression | 0.1143a² − 3.3143a + 37.314 | 0.072a² − 2.9a + 36.3 |

Point P

| | | | | | | | |
|---|---|---|---|---|---|---|---|
| a = HFO-1132a | mass % | 1.5 | 3.0 | 5.0 | 5.0 | 7.5 | 10.0 |
| R32 | mass % | 58.9 | 59.0 | 59.0 | 59.0 | 59.0 | 59.0 |
| R1234yf | mass % | 15.2 | 19.7 | 23.9 | 23.9 | 27.0 | 28.4 |
| R1234ze | mass % | 24.4 | 18.3 | 12.1 | 12.1 | 6.5 | 2.6 |

| | | |
|---|---|---|
| R32 approximate expression | −0.019a² + 0.1524a + 58.714 | 59.0 |
| R1234yf approximate expression | −0.2571a² + 4.1571a + 9.5429 | −0.136a² + 2.94a + 12.6 |
| R1234ze approximate expression | 0.2761a² − 5.3095a + 31.7431 | 0.136a² − 3.94a + 28.4 |

Point R

| | | | |
|---|---|---|---|
| x = HFO-1132a | mass % | 7.5 | 10.0 |
| R32 | mass % | 73.9 | 73.9 |
| R1234yf | mass % | 0.0 | 2.8 |
| R1234ze | mass % | 18.6 | 13.3 |

| | |
|---|---|
| R32 approximate expression | 73.9 |
| R1234yf approximate expression | 1.12a − 8.4 |
| R1234ze approximate expression | −2.12a + 34.5 |

For each mixed refrigerant, the COP ratio and refrigerating capacity ratio relative to those of R404A were determined. The calculation conditions were as follows:
Evaporating temperature: −40° C.
Condensation temperature: 40° C.
Superheating temperature: 20 K
Subcooling temperature: 0 K
Compressor efficiency: 70%

Tables 7 and 8 show these values together with the GWP of each mixed refrigerant. The COP and refrigerating capacity are ratios relative to R404A.

The coefficient of performance (COP) was determined according the following formula.

COP=(refrigerating capacity or heating capacity)/power consumption

Various properties of the mixed refrigerants were evaluated as shown in Tables 7 and 8 while changing the concentration of HFO-1132a.

TABLE 7

| | | Comp. | Comp. | Comp. | | | | | | Comp. | Comp. |
|---|---|---|---|---|---|---|---|---|---|---|---|
| Item | Unit | Ex. 56 | Ex. 74 | Ex. 75 | Ex. 36 | Ex. 37 | Ex. 38 | Ex. 39 | Ex. 40 | Ex. 76 | Ex. 77 |
| HFO-1132a | mass % | R404A | 0.0 | 0.75 | 1.5 | 3.0 | 5.0 | 7.5 | 10.0 | 12.5 | 15.0 |
| R32 | mass % | | 21.5 | 21.5 | 21.5 | 21.5 | 21.5 | 21.5 | 21.5 | 21.5 | 21.5 |
| R1234ze | mass % | | 78.5 | 77.75 | 77.0 | 75.5 | 73.5 | 71.0 | 68.5 | 66.0 | 63.5 |
| GWP | — | 2088 | 150 | 150 | 150 | 150 | 150 | 149 | 149 | 149 | 149 |
| COP ratio | % (relative to | 100.0 | 113.1 | 112.6 | 112.0 | 111.0 | 109.6 | 108.0 | 106.5 | 105.0 | 103.6 |
| | R404A) | | | | | | | | | | |
| Refrigerating | % (relative to | 100.0 | 66.4 | 67.9 | 69.3 | 72.1 | 75.8 | 80.6 | 85.3 | 90.2 | 95.2 |
| capacity ratio | R404A) | | | | | | | | | | |
| Condensation | ° C. | 0 | 10.9 | 12.3 | 13.5 | 15.6 | 17.8 | 19.8 | 21.1 | 21.9 | 22.3 |
| temperature glide | | | | | | | | | | | |
| Evaporation | ° C. | 0.1 | 6.4 | 6.7 | 7.0 | 7.7 | 8.5 | 9.6 | 10.5 | 11.5 | 12.4 |
| temperature glide | | | | | | | | | | | |

TABLE 8

| | | Comp. | | | Comp. | | Comp. |
|---|---|---|---|---|---|---|---|
| | | Ex. 78 | Ex. 41 | Ex. 42 | Ex. 79 | Ex. 43 | Ex. 80 |
| Item | Unit | L | T | M | A″ | S | B″ |
| HFO-1132a | mass % | 1.5 | 1.9 | 10.0 | 77.9 | 10.0 | 1.5 |
| R32 | mass % | 22.0 | 21.5 | 12.5 | 22.1 | 21.5 | 21.5 |
| R1234ze | mass % | 76.5 | 76.6 | 77.5 | 0.0 | 68.5 | 77.0 |
| GWP | — | 153 | 150 | 89 | 150 | 149 | 150 |
| COP ratio | % (relative to | 112.0 | 111.7 | 105.7 | — | 106.5 | 112.0 |
| | R410A) | | | | | | |
| Refrigerating | % (relative to | 70.0 | 70.0 | 70.0 | | 85.3 | 69.3 |
| capacity ratio | R410A) | | | | | | |
| Condensation | ° C. | 13.4 | 14.1 | 24.5 | | 21.1 | 13.5 |
| temperature glide | | | | | | | |
| Evaporation | ° C. | 7.1 | 7.2 | 8.4 | | 10.5 | 7.0 |
| temperature glide | | | | | | | |

| | | Comp. | Comp. | Comp. | Comp. | Comp. | | Comp. | | Comp. |
|---|---|---|---|---|---|---|---|---|---|---|
| | | Ex. 81 | Ex. 82 | Ex. 83 | Ex. 84 | Ex. 85 | Ex. 44 | Ex. 86 | Ex. 45 | Ex. 87 |
| Item | Unit | A″ | B″ | L | L′ | M | T | A″ | B″ = L = T | M |
| HFO-1132a | mass % | 1.5 | 1.5 | 1.5 | 1.5 | 1.5 | 1.5 | 1.9 | 1.9 | 1.9 |
| ER32 | mass % | 21.8 | 21.5 | 21.8 | 21.5 | 8.9 | 21.5 | 21.8 | 21.5 | 8.5 |
| R1234yf | mass % | 76.7 | 0.00 | 76.7 | 0.0 | 89.6 | 6.0 | 76.3 | 0.0 | 89.6 |
| R1234ze | mass % | 0.0 | 77.00 | 0.0 | 77.0 | 0.0 | 71.0 | 0.0 | 76.6 | 0.0 |
| GWP | — | 150 | 150 | 153 | 109 | 64 | 150 | 150 | 150 | 61 |
| COP ratio | % (relative to | 107.4 | 112.0 | 112.0 | 109.5 | 106.7 | 111.7 | 107.3 | 111.7 | 106.5 |
| | R404A) | | | | | | | | | |
| Refrigerating | % (relative to | 91.7 | 69.3 | 70.0 | 70.0 | 70.0 | 70.9 | 92.4 | 70.0 | 70.0 |
| capacity ratio | R404A) | | | | | | | | | |
| Condensation | ° C. | 7.7 | 13.5 | 13.4 | 10.8 | 7.7 | 13.0 | 7.9 | 14.1 | 7.9 |
| temperature glide | | | | | | | | | | |
| Evaporation | ° C. | 4.4 | 7.0 | 7.1 | 5.2 | 2.5 | 7.0 | 4.5 | 7.2 | 2.5 |
| temperature glide | | | | | | | | | | |

| | | Comp. | | | Comp. | Comp. | | | Comp. |
|---|---|---|---|---|---|---|---|---|---|
| | | Ex. 88 | Ex. 46 | Ex. 47 | Ex. 89 | Ex. 90 | Ex. 48 | Ex. 49 | Ex. 91 |
| Item | Unit | A″ | B″ | L | M | A″ | B″ | L | M |
| HFO-1132a | mass % | 6.0 | 6.0 | 6.0 | 6.0 | 10.0 | 10.0 | 10.0 | 10.0 |
| R32 | mass % | 21.8 | 21.5 | 16.8 | 4.6 | 21.8 | 21.6 | 12.5 | 0.9 |
| R1234yf | mass % | 72.2 | 0.00 | 0.0 | 89.4 | 68.2 | 0.0 | 0.0 | 89.1 |
| R1234ze | mass % | 0.0 | 72.50 | 77.2 | 0.0 | 0.0 | 68.4 | 77.5 | 0.0 |
| GWP | — | 150 | 150 | 118 | 35 | 150 | 150 | 89 | 10 |
| COP ratio | % (relative to | 105.9 | 109.0 | 108.7 | 105.3 | 104.5 | 106.5 | 105.7 | 104.3 |
| | R404A) | | | | | | | | |
| Refrigerating | % (relative to | 100.2 | 77.7 | 70.0 | 70.0 | 108.0 | 85.5 | 70.0 | 70.0 |
| capacity ratio | R404A) | | | | | | | | |
| Condensation | ° C. | 9.9 | 18.6 | 19.9 | 10.5 | 11.3 | 21.1 | 24.5 | 12.4 |
| temperature glide | | | | | | | | | |
| Evaporation | ° C. | 5.5 | 8.9 | 7.9 | 2.7 | 6. | 10.6 | 8.4 | 3.0 |
| temperature glide | | | | | | | | | |

Tables 7 and 8 indicate that the mixed refrigerants have a GWP of 150 or less and a refrigerating capacity ratio of 70% or more relative to that of R404A when they satisfy the following requirements.

### Requirements

When the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines ST, TM, and MS that connect the following three points:
point S (10.0, 21.5, 68.5),
point T (1.9, 21.5, 76.6), and
point M (10.0, 12.5, 77.5),
or on the straight lines.

Tables 7 and 8 indicate that the mixed refrigerants have a GWP of 150 or less and a refrigerating capacity ratio of 70% or more relative to that of R404A when they satisfy the following requirements.

### Requirements

When the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 1.9≥x≥1.5, coordinates (x,y,z) in a ternary composition diagram in which the sum of R32, R1234yf, and R1234ze is (100−a) mass % are within the range of a figure surrounded by straight lines A″T, TM, and MA″ that connect the following three points:
point A″ (21.8, −a+78.2, 0.0),
point T (21.5, −15.0a+28.5, 14.0a+50.0), and
point M (0.0035a²−0.9809a+10.358, −0.0035a²−0.0191a+89.642, 0.0),
or on the straight lines A″T and TM (excluding the points A″ and M), or
if 10.0≥x≥1.9, coordinates (x,y,z) in the ternary composition diagram are within the range of a figure surrounded by straight lines A″B″, B″L, LM, and MA″ that connect the following four points:
point A″ (21.8, −a+78.2, 0.0),
point B″ (0.0108a+21.473, 0.0, −1.0108a+78.527),
point L (0.0098a²−1.2237a+23.804, 0.0, −0.0098a²+0.2237a+76.196), and
point M (0.0035a²−0.9809a+10.358, −0.0035a=−0.0191a+89.642, 0.0),
or on the straight lines A″B″ and LM (excluding the points A″, B″, L, and M).

Approximate expressions indicating the coordinates of each point were obtained by determining approximate expressions for the curves connecting three points, as shown in Table 9.

TABLE 9
A″

| | | | | | |
|---|---|---|---|---|---|
| a = HFO-1132a | mass % | 1.5 | 1.9 | 6.0 | 10.0 |
| R32 | mass % | 21.8 | 21.8 | 21.8 | 21.8 |
| R1234yf | mass % | 76.7 | 76.3 | 72.2 | 68.2 |
| R1234ze | mass % | 0.0 | 0.0 | 0.0 | 0.0 |

| | |
|---|---|
| R32 approximate expression | 21.8 |
| R1234yf approximate expression | −a + 78.2 |
| R1234ze approximate expression | 0.0 |

B″

| | | | | | |
|---|---|---|---|---|---|
| a = HFO-1132a | mass % | 1.5 | 1.9 | 6.0 | 10.0 |
| R32 | mass % | 21.5 | 21.5 | 21.5 | 21.6 |
| R1234yf | mass % | 0.0 | 0.0 | 0.0 | 0.0 |
| R1234ze | mass % | 77.0 | 76.6 | 72.5 | 68.4 |

| | |
|---|---|
| R32 approximate expression | 0.0108a + 21.473 |
| R1234yf approximate expression | 0.0 |
| R1234ze approximate expression | −1.0108a + 78.527 |

L

| | | | | | |
|---|---|---|---|---|---|
| a = HFO-1132a | mass % | 1.5 | 1.9 | 6.0 | 10.0 |
| R32 | mass % | 22.0 | 21.5 | 16.8 | 12.5 |
| R1234yf | mass % | 0.0 | 0.0 | 0.0 | 0.0 |
| R1234ze | mass % | 76.5 | 76.6 | 77.2 | 77.5 |

| | |
|---|---|
| R32 approximate expression | 0.0098a²-1.2237a + 23.804 |
| R1234yf approximate expression | 0.0 |
| R1234ze approximate expression | −0.0098a² + 0.2237a + 76.196 |

M

| | | | | | |
|---|---|---|---|---|---|
| a = HFO-1132a | mass % | 1.5 | 1.9 | 6.0 | 10.0 |
| R32 | mass % | 8.9 | 8.5 | 4.6 | 0.9 |
| R1234yf | mass % | 89.6 | 89.6 | 89.4 | 89.1 |
| R1234ze | mass % | 0.0 | 0.0 | 0.0 | 0.0 |

| | |
|---|---|
| R32 approximate expression | 0.0035a²-0.9809a + 10.358 |
| R1234yf approximate expression | −0.0035a²-0.0191a + 89.642 |
| R1234ze approximate expression | 0.0 |

T

| | | | |
|---|---|---|---|
| a = HFO-1132a | mass % | 1.5 | 1.9 |
| R32 | mass % | 21.5 | 21.5 |
| R1234yf | mass % | 6.0 | 0.0 |
| R1234ze | mass % | 71.0 | 76.6 |

| | |
|---|---|
| R32 approximate expression | 21.5 |
| R1234yf approximate expression | −15.0a + 28.5 |
| R1234ze approximate expression | 14.0a + 50.0 |

The following mixed refrigerants were also evaluated in the same manner.

TABLE 10

| | | Comp. | Comp. | Comp. | Comp. | Comp. | Comp. | Comp. | Comp. |
|---|---|---|---|---|---|---|---|---|---|
| Item | Unit | Ex. 92 | Ex. 93 | Ex. 94 | Ex. 95 | Ex. 96 | Ex. 97 | Ex. 98 | Ex. 99 |
| HFO-1132a | mass % | 3.0 | 5.0 | 7.0 | 12.5 | 3.0 | 5.0 | 7.0 | 12.5 |
| R32 | mass % | 15.0 | 15.0 | 15.0 | 15.0 | 20.0 | 20.0 | 20.0 | 20.0 |
| R1234y | mass % | 0.0 | 0.0 | 0.0 | 0.0 | 0.0 | 0.0 | 0.0 | 0.0 |
| R1234ze | mass % | 82.0 | 80.0 | 78.0 | 72.5 | 77.0 | 75.0 | 73.0 | 67.5 |
| GWP | — | 106 | 106 | 106 | 106 | 140 | 140 | 139 | 139 |
| COP ratio | % (relative to | 105.6 | 104.7 | 104.1 | 102.7 | 105.7 | 104.8 | 104.1 | 102.4 |
| | R410A) | | | | | | | | |
| Refrigerating | % (relative to | 54.9 | 58.5 | 62.1 | 71.5 | 59.5 | 63.0 | 66.5 | 75.6 |
| capacity ratio | R410A) | | | | | | | | |
| Condensation | ° C. | 15.7 | 18.4 | 20.5 | 23.6 | 15.2 | 17.4 | 19.0 | 21.5 |
| temperature glide | | | | | | | | | |
| | | Comp. | Comp. | | Comp. | Comp. | | | Comp. |
| Item | Unit | Ex. 100 | Ex. 101 | Ex. 50 | Ex. 102 | Ex 103 | Ex. 51 | Ex. 52 | Ex. 104 |
| HFO-11328 | mass % | 3.0 | 5.0 | 7.0 | 12.5 | 3.0 | 5.0 | 7.0 | 12.5 |
| R32 | mass % | 25.0 | 25.0 | 25.0 | 25.0 | 30.0 | 30.0 | 30.0 | 30.0 |
| R1234yf | mass % | 0.0 | 0.0 | 0.0 | 0.0 | 0.0 | 0.0 | 0.0 | 0.0 |
| R1234ze | mass % | 72.0 | 70.0 | 68.0 | 62.5 | 67.0 | 65.0 | 63.0 | 57.5 |
| GWP | — | 173 | 173 | 173 | 173 | 207 | 206 | 206 | 206 |
| COP ratio | % (relative to | 105.5 | 104.6 | 103.8 | 101.9 | 105.1 | 104.2 | 103.4 | 101.3 |
| | R410A) | | | | | | | | |
| Refrigerating | % (relative to | 63.8 | 67.3 | 70.6 | 79.4 | 67.9 | 71.3 | 74.5 | 83.1 |
| capacity ratio | R410A) | | | | | | | | |
| Condensation | ° C. | 14.4 | 16.2 | 17.5 | 19.5 | 13.4 | 14.9 | 16.0 | 17.6 |
| temperature glide | | | | | | | | | |
| | | | | | Comp. | | | | Comp. |
| Item | Unit | Ex. 53 | Ex. 54 | Ex. 55 | Ex. 105 | Ex. 56 | Ex. 57 | Ex. 58 | Ex. 106 |
| HFO-11328 | mass % | 3.0 | 5.0 | 7.0 | 12.5 | 3.0 | 5.0 | 7.0 | 12.5 |
| R32 | mass % | 35.0 | 35.0 | 35.0 | 35.0 | 40.0 | 40.0 | 40.0 | 40.0 |
| R1234yf | mass % | 0.0 | 0.0 | 0.0 | 0.0 | 0.0 | 0.0 | 0.0 | 0.0 |
| R1234ze | mass % | 62.0 | 60.0 | 58.0 | 52.5 | 57.0 | 55.0 | 53.0 | 47.5 |
| GWP | — | 240 | 240 | 240 | 240 | 273 | 273 | 273 | 273 |
| COP ratio | % (relative to | 104.7 | 103.7 | 102.9 | 100.8 | 104.2 | 103.3 | 102.5 | 100.4 |
| | R410A) | | | | | | | | |
| Refrigerating | % (relative to | 71.8 | 75.1 | 78.3 | 86.8 | 75.6 | 78.8 | 82.0 | 90.4 |
| capacity ratio | R410A) | | | | | | | | |
| Condensation | ° C. | 12.3 | 13.6 | 14.5 | 15.8 | 11.2 | 12.2 | 13.0 | 14.1 |
| temperature glide | | | | | | | | | |
| | | | | | Comp. | | | | Comp. |
| Item | Unit | Ex. 59 | Ex. 60 | Ex. 61 | Ex. 107 | Ex. 62 | Ex. 63 | Ex. 64 | Ex. 108 |
| HFO-11323 | mass % | 3.0 | 5.0 | 7.0 | 12.5 | 3.0 | 5.0 | 7.0 | 12.5 |
| R32 | mass % | 45.0 | 45.0 | 45.0 | 45.0 | 50.0 | 50.0 | 50.0 | 50.0 |
| R1234yf | mass % | 0.0 | 0.0 | 0.0 | 0.0 | 0.0 | 0.0 | 0.0 | 0.0 |
| R1234ze | mass % | 52.0 | 50.0 | 48.0 | 42.5 | 47.0 | 45.0 | 43.0 | 37.5 |
| GWP | — | 307 | 307 | 307 | 306 | 340 | 340 | 340 | 340 |
| COP ratio | % (relative to | 103.7 | 102.9 | 102.1 | 100.0 | 103.4 | 102.5 | 101.8 | 99.8 |
| | R410A) | | | | | | | | |
| Refrigerating | % (relative to | 79.3 | 82.5 | 85.6 | 94.0 | 83.0 | 86.1 | 89.2 | 97.5 |
| capacity ratio | R410A) | | | | | | | | |
| Condensation | ° C. | 10.0 | 10.9 | 11.6 | 12.5 | 8.9 | 9.7 | 10.2 | 11.0 |
| temperature glide | | | | | | | | | |
| | | | | | Comp. | | | | Comp. |
| Item | Unit | Ex. 65 | Ex. 66 | Ex. 67 | Ex. 109 | Ex. 68 | Ex. 69 | Ex. 70 | Ex. 110 |
| HFO-1132a | mass % | 3.0 | 5.0 | 7.0 | 12.5 | 3.0 | 5.0 | 7.0 | 12.5 |
| R32 | mass % | 55.0 | 55.0 | 55.0 | 55.0 | 60.0 | 60.0 | 60.0 | 60.0 |
| R1234yf | mass % | 0.0 | 0.0 | 0.0 | 0.0 | 0.0 | 0.0 | 0.0 | 0.0 |
| R1234ze | mass % | 42.0 | 40.0 | 38.0 | 32.5 | 37.0 | 35.0 | 33.0 | 27.5 |
| GWP | — | 374 | 374 | 374 | 373 | 407 | 407 | 407 | 407 |
| COP ratio | % (relative to | 103.0 | 102.3 | 101.5 | 99.6 | 102.8 | 102.0 | 101.3 | 99.5 |
| | R410A) | | | | | | | | |
| Refrigerating | % (relative to | 86.5 | 89.7 | 92.8 | 101.0 | 90.0 | 93.2 | 96.2 | 104.4 |
| capacity ratio | R410A) | | | | | | | | |
| Condensation | ° C. | 7.7 | 8.4 | 8.9 | 9.6 | 6.7 | 7.3 | 7.8 | 8.3 |
| temperature glide | | | | | | | | | |
| | | | | | Comp. | | | | Comp. |
| Item | Unit | Ex. 71 | Ex. 72 | Ex. 73 | Ex. 111 | Ex. 74 | Ex. 75 | Ex. 76 | Ex. 112 |
| HFO-1132a | mass % | 3.0 | 5.0 | 7.0 | 12.5 | 3.0 | 5.0 | 7.0 | 12.5 |
| R32 | mass % | 65.0 | 65.0 | 65.0 | 65.0 | 70.0 | 70.0 | 70.0 | 70.0 |
| R1234yf | mass % | 0.0 | 0.0 | 0.0 | 0.0 | 0.0 | 0.0 | 0.0 | 0.0 |
| R1234ze | mass % | 32.0 | 30.0 | 28.0 | 22.5 | 27.0 | 25.0 | 23.0 | 17.5 |
| GWP | — | 441 | 441 | 441 | 440 | 474 | 474 | 474 | 474 |
| COP ratio | % (relative to | 102.6 | 101.9 | 101.2 | 99.4 | 102.4 | 101.8 | 101.1 | 99.3 |
| | R410A) | | | | | | | | |
| Refrigerating | % (relative to | 93.5 | 96.6 | 99.6 | 107.7 | 96.8 | 99.9 | 102.9 | 110.9 |
| capacity ratio | R410A) | | | | | | | | |
| Condensation | ° C. | 5.7 | 6.2 | 6.7 | 7.2 | 4.8 | 5.3 | 5.6 | 6.1 |
| temperature glide | | | | | | | | | |

| | | Comp. | Comp. | Comp. | Comp. |
|---|---|---|---|---|---|
| Item | Unit | Ex. 113 | Ex. 114 | Ex. 115 | Ex. 116 |
| HFO-1132a | mass % | 3.0 | 5.0 | 7.0 | 12.5 |
| R32 | mass % | 80.0 | 80.0 | 80.0 | 80.0 |
| R1234yf | mass % | 0.0 | 0.0 | 0.0 | 0.0 |
| R1234ze | mass % | 17.0 | 15.0 | 13.0 | 7.5 |
| GWP | — | 541 | 541 | 541 | 541 |
| COP ratio | % (relative to | 102.2 | 101.5 | 100.9 | 99.2 |
| | R410A) | | | | |
| Refrigerating | % (relative to | 103.1 | 106.1 | 109.0 | 116.8 |
| capacity ratio | R410A) | | | | |
| Condensation | ° C. | 3.1 | 3.5 | 3.9 | 4.4 |
| temperature glide | | | | | |

TABLE 11

| | | Comp. | Comp. | Comp. | Comp. | Comp. | Comp. | Comp. | |
|---|---|---|---|---|---|---|---|---|---|
| Item | Unit | Ex. 117 | Ex. 118 | Ex. 119 | Ex. 120 | Ex. 121 | Ex. 122 | Ex. 123 | Ex. 77 |
| HFO-1132a | mass % | 1.6 | 1.5 | 1.5 | 1.5 | 1.5 | 1.5 | 1.5 | 1.5 |
| R32 | mass % | 20.0 | 20.0 | 20.0 | 20.0 | 20.0 | 20.0 | 20.0 | 30.0 |
| R1234yf | mass % | 68.5 | 58.5 | 48.5 | 38.5 | 28.5 | 18.5 | 8.5 | 58.5 |
| R1234ze | mass % | 10.0 | 20.0 | 30.0 | 40.0 | 50.0 | 60.0 | 70.0 | 10.0 |
| GWP | — | 138 | 139 | 139 | 139 | 139 | 139 | 140 | 205 |
| COP ratio | % (relative | 103.5 | 103.9 | 104.4 | 104.9 | 105.4 | 105.8 | 106.3 | 102.7 |
| | to R410A) | | | | | | | | |
| Refrigerating | % (relative | 65.2 | 64.1 | 63.0 | 61.7 | 60.5 | 59.2 | 57.9 | 73.3 |
| capacity ratio | to R410A) | | | | | | | | |
| Condensation | ° C. | 8.1 | 8.8 | 9.4 | 10.1 | 10.9 | 11.7 | 12.4 | 6.9 |
| temperature glide | | | | | | | | | |
| | | | | Comp. | Comp. | Comp. | | | |
| Item | Unit | Ex. 78 | Ex. 79 | Ex. 124 | Ex. 125 | Ex. 126 | Ex. 80 | Ex. 81 | Ex. 82 |
| HFO-1132a | mass % | 1.5 | 1.5 | 1.5 | 1.5 | 1.5 | 1.5 | 1.5 | 1.5 |
| R32 | mass % | 30.0 | 30.0 | 30.0 | 30.0 | 30.0 | 40.0 | 40.0 | 40.0 |
| R1234yf | mass % | 48.5 | 38.5 | 28.5 | 18.5 | 8.5 | 48.5 | 38.5 | 28.5 |
| R1234ze | mass % | 20.0 | 30.0 | 40.0 | 50.0 | 60.0 | 10.0 | 20.0 | 30.0 |
| GWP | — | 206 | 206 | 206 | 206 | 206 | 273 | 273 | 273 |
| COP ratio | % (relative | 103.3 | 103.8 | 104.4 | 104.9 | 105.5 | 102.3 | 102.8 | 103.3 |
| | to R410A) | | | | | | | | |
| Refrigerating | % (relative | 72.0 | 70.7 | 69.4 | 68.0 | 66.6 | 80.5 | 79.0 | 77.5 |
| capacity ratio | to R410A) | | | | | | | | |
| Condensation | ° C. | 7.7 | 8.5 | 9.4 | 10.3 | 11.2 | 5.5 | 6.4 | 7.3 |
| temperature glide | | | | | | | | | |
| Item | Unit | Ex. 83 | Ex. 84 | Ex. 85 | Ex. 86 | Ex. 87 | Ex. 88 | Ex. 89 | Ex. 90 |
| HFO-1132a | mass % | 1.5 | 1.5 | 1.5 | 1.5 | 1.5 | 1.5 | 1.5 | 1.5 |
| R32 | mass % | 40.0 | 40.0 | 50.0 | 50.0 | 50.0 | 50.0 | 60.0 | 60.0 |
| R1234yf | mass % | 18.5 | 8.5 | 38.5 | 28.5 | 18.5 | 8.5 | 28.5 | 18.5 |
| R1234ze | mass % | 40.0 | 50.0 | 10.0 | 20.0 | 30.0 | 40.0 | 10.0 | 20.0 |
| GWP | — | 273 | 273 | 340 | 340 | 340 | 340 | 407 | 407 |
| COP ratio | % (relative | 103.9 | 104.4 | 102.2 | 102.6 | 103.1 | 103.6 | 102.2 | 102.6 |
| | to R410A) | | | | | | | | |
| Refrigerating | % (relative | 76.0 | 74.5 | 86.9 | 85.3 | 83.6 | 82.0 | 92.7 | 91.0 |
| capacity ratio | to R410A) | | | | | | | | |
| Condensation | ° C. | 8.3 | 9.3 | 4.2 | 5.2 | 6.2 | 7.2 | 3.3 | 4.2 |
| temperature glide | | | | | | | | | |

| | | | | | Comp. |
|---|---|---|---|---|---|
| Item | Unit | Ex. 91 | Ex. 92 | Ex. 93 | Ex. 127 |
| HFO-1132a | mass % | 1.5 | 1.5 | 1.5 | 1.5 |
| R32 | mass % | 60.0 | 70.0 | 70.0 | 80.0 |
| R1234yf | mass % | 8.5 | 18.5 | 8.5 | 8.5 |
| R1234ze | mass % | 30.0 | 10.0 | 20.0 | 10.0 |
| GWP | — | 407 | 474 | 474 | 541 |
| COP ratio | % (relative | 103.0 | 102.3 | 102.7 | 102.4 |
| | to R410A) | | | | |
| Refrigerating | % (relative | 89.2 | 97.8 | 96.0 | 102.4 |
| capacity ratio | to R410A) | | | | |
| Condensation | ° C. | 5.2 | 2.5 | 3.4 | 2.0 |
| temperature glide | | | | | |

TABLE 12

| | | Comp. | Comp. | Comp. | Comp. | Comp. | Comp. | Comp. | |
|---|---|---|---|---|---|---|---|---|---|
| Item | Unit | Ex. 128 | Ex. 129 | Ex. 130 | Ex. 131 | Ex. 132 | Ex. 133 | Ex. 134 | Ex. 94 |
| HFO-1132a | mass % | 3.0 | 3.0 | 3.0 | 3.0 | 3.0 | 3.0 | 3.0 | 3.0 |
| R32 | mass % | 20.0 | 20.0 | 20.0 | 20.0 | 20.0 | 20.0 | 20.0 | 30.0 |
| R1234y1 | mass % | 67.0 | 57.0 | 47.0 | 37.0 | 27.0 | 17.0 | 7.0 | 57.0 |
| R1234ze | mass % | 10.0 | 20.0 | 30.0 | 40.0 | 50.0 | 60.0 | 70.0 | 10.0 |
| GWP | — | 138 | 139 | 139 | 139 | 139 | 139 | 140 | 205 |
| COP ratio | % (relative to | 103.0 | 103.4 | 103.9 | 104.3 | 104.7 | 105.1 | 105.5 | 102.2 |
| | R410A) | | | | | | | | |
| Refrigerating | % (relative to | 67.3 | 66.2 | 65.1 | 64.0 | 62.8 | 61.6 | 60.4 | 75.3 |
| capacity ratio | R410A) | | | | | | | | |
| Condensation | ° C. | 9.0 | 9.8 | 10.6 | 11.5 | 12.4 | 13.4 | 14.4 | 7.6 |
| temperature glide | | | | | | | | | |
| | | | | | Comp. | | | | |
| Item | Unit | Ex. 95 | Ex. 96 | Ex. 97 | Ex. 135 | Ex. 98 | Ex. 99 | Ex. 100 | Ex. 101 |
| HFO-1132a | mass % | 3.0 | 3.0 | 3.0 | 3.0 | 3.0 | 3.0 | 3.0 | 3.0 |
| R32 | mass % | 30.0 | 30.0 | 30.0 | 30.0 | 40.0 | 40.0 | 40.0 | 40.0 |
| R1234yt | mass % | 47.0 | 37.0 | 27.0 | 7.0 | 47.0 | 37.0 | 27.0 | 17.0 |
| R1234ze | mass % | 20.0 | 30.0 | 40.0 | 60.0 | 10.0 | 20.0 | 30.0 | 40.0 |
| GWP | — | 206 | 206 | 206 | 206 | 273 | 273 | 273 | 273 |
| COP ratio | % (relative to | 102.7 | 103.2 | 103.8 | 104.8 | 101.8 | 102.3 | 102.8 | 103.3 |
| | R410A) | | | | | | | | |
| Refrigerating | % (relative to | 74.1 | 72.8 | 71.5 | 68.9 | 82.5 | 81.1 | 79.6 | 78.1 |
| capacity ratio | R410A) | | | | | | | | |
| Condensation | ° C. | 8.5 | 9.5 | 10.5 | 12.6 | 6.1 | 7.1 | 8.1 | 9.2 |
| temperature glide | | | | | | | | | |
| Item | Unit | Ex. 102 | Ex. 103 | Ex. 104 | Ex. 105 | Ex. 106 | Ex. 107 | Ex. 108 | Ex. 109 |
| HFO-1132a | mass % | 3.0 | 3.0 | 3.0 | 3.0 | 3.0 | 3.0 | 3.0 | 3.0 |
| R32 | mass % | 40.0 | 50.0 | 50.0 | 50.0 | 50.0 | 60.0 | 60.0 | 60.0 |
| R1234yt | mass % | 7.0 | 37.0 | 27.0 | 17.0 | 7.0 | 27.0 | 17.0 | 7.0 |
| R1234ze | mass % | 50.0 | 10.0 | 20.0 | 30.0 | 40.0 | 10.0 | 20.0 | 30.0 |
| GWP | — | 273 | 340 | 340 | 340 | 340 | 407 | 407 | 407 |
| COP ratio | % (relative to | 103.8 | 101.7 | 102.1 | 102.6 | 103.0 | 101.7 | 102.1 | 102.5 |
| | R410A) | | | | | | | | |
| Refrigerating | % (relative to | 76.7 | 88.9 | 87.4 | 85.7 | 84.1 | 94.7 | 93.0 | 91.3 |
| capacity ratio | R410A) | | | | | | | | |
| Condensation | ° C. | 10.4 | 4.8 | 5.8 | 6.9 | 8.1 | 3.8 | 4.8 | 5.9 |
| temperature glide | | | | | | | | | |

| | | | | Comp. |
|---|---|---|---|---|
| Item | Unit | Ex. 110 | Ex. 111 | Ex. 136 |
| HFO-1132a | mass % | 3.0 | 3.0 | 3.0 |
| R32 | mass % | 70.0 | 70.0 | 80.0 |
| R1234yf | mass % | 17.0 | 7.0 | 7.0 |
| R1234ze | mass % | 10.0 | 20.0 | 10.0 |
| GWP | — | 474 | 474 | 541 |
| COP ratio | % (relative to | 101.8 | 102.2 | 101.9 |
| | R410A) | | | |
| Refrigerating | % (relative to | 99.8 | 98.1 | 104.3 |
| capacity ratio | R410A) | | | |
| Condensation | ° C. | 3.1 | 4.0 | 2.5 |
| temperature glide | | | | |

TABLE 13

| | | Comp. | Comp. | Comp. | Comp. | Comp. | Comp. | | |
|---|---|---|---|---|---|---|---|---|---|
| Item | Unit | Ex. 137 | Ex. 138 | Ex. 139 | Ex. 140 | Ex. 141 | Ex. 142 | Ex. 112 | Ex. 113 |
| HFO-1132a | mass % | 5.0 | 5.0 | 5.0 | 5.0 | 5.0 | 5.0 | 5.0 | 5.0 |
| R32 | mass % | 20.0 | 20.0 | 20.0 | 20.0 | 20.0 | 20.0 | 30.0 | 30.0 |
| R1234yf | mass % | 55.0 | 45.0 | 35.0 | 25.0 | 15.0 | 5.0 | 55.0 | 45.0 |
| R1234ze | mass % | 20.0 | 30.0 | 40.0 | 50.0 | 60.0 | 70.0 | 10.0 | 20.0 |
| GWP | — | 138 | 139 | 139 | 139 | 139 | 139 | 205 | 206 |
| COP ratio | % (relative to | 102.8 | 103.2 | 103.6 | 104.0 | 104.3 | 104.7 | 101.6 | 102.1 |
| | R410A) | | | | | | | | |
| Refrigerating | % (relative to | 69.0 | 68.0 | 66.9 | 65.8 | 64.7 | 63.6 | 78.0 | 76.9 |
| capacity ratio | R410A) | | | | | | | | |
| Condensation | ° C. | 11.0 | 12.0 | 13.0 | 14.2 | 15.4 | 16.7 | 8.4 | 9.4 |
| temperature glide | | | | | | | | | |
| Item | Unit | Ex. 114 | Ex. 115 | Ex. 116 | Ex. 117 | Ex. 118 | Ex. 119 | Ex. 120 | Ex. 121 |
| HFO-11328 | mass % | 5.0 | 5.0 | 5.0 | 5.0 | 5.0 | 5.0 | 5.0 | 5.0 |
| R32 | mass % | 30.0 | 30.0 | 30.0 | 30.0 | 40.0 | 40.0 | 40.0 | 40.0 |
| R1234yf | mass % | 35.0 | 25.0 | 15.0 | 5.0 | 45.0 | 35.0 | 25.0 | 15.0 |
| R1234ze | mass % | 30.0 | 40.0 | 50.0 | 60.0 | 10.0 | 20.0 | 30.0 | 40.0 |
| GWP | — | 206 | 206 | 206 | 206 | 272 | 273 | 273 | 273 |
| COP ratio | % (relative to | 102.5 | 103.0 | 103.5 | 104.0 | 101.1 | 101.6 | 102.1 | 102.5 |
| | R410A) | | | | | | | | |
| Refrigerating | % (relative to | 75.7 | 74.4 | 73.1 | 71.9 | 85.2 | 83.8 | 82.4 | 81.0 |
| capacity ratio | R410A) | | | | | | | | |
| Condensation | ° C. | 10.5 | 11.7 | 13.0 | 14.2 | 6.8 | 7.9 | 9.1 | 10.3 |
| temperature glide | | | | | | | | | |
| Item | Unit | Ex. 122 | Ex. 123 | Ex. 124 | Ex. 125 | Ex. 126 | Ex. 127 | Ex. 128 | Ex. 129 |
| HFO-1132a | mass % | 5.0 | 5.0 | 5.0 | 5.0 | 5.0 | 5.0 | 5.0 | 5.0 |
| R32 | mass % | 40.0 | 50.0 | 50.0 | 50.0 | 50.0 | 60.0 | 60.0 | 60.0 |
| R1234yf | mass % | 5.0 | 35.0 | 25.0 | 15.0 | 5.0 | 25.0 | 15.0 | 5.0 |
| R1234ze | mass % | 50.0 | 10.0 | 20.0 | 30.0 | 40.0 | 10.0 | 20.0 | 30.0 |
| GWP | — | 273 | 340 | 340 | 340 | 340 | 407 | 407 | 407 |
| COP ratio | % (relative to | 103.0 | 101.1 | 101.5 | 101.9 | 102.3 | 101.1 | 101.5 | 101.9 |
| | R410A) | | | | | | | | |
| Refrigerating | % (relative to | 79.6 | 91.6 | 90.1 | 88.5 | 86.9 | 97.4 | 95.7 | 94.0 |
| capacity ratio | R410A) | | | | | | | | |
| Condensation | ° C. | 11.6 | 5.5 | 6.6 | 7.8 | 9.0 | 4.5 | 5.5 | 6.7 |
| temperature glide | | | | | | | | | |

| | | | | Comp. |
|---|---|---|---|---|
| Item | Unit | Ex. 130 | Ex. 131 | Ex. 143 |
| HFO-11328 | mass % | 5.0 | 5.0 | 5.0 |
| R32 | mass % | 70.0 | 70.0 | 80.0 |
| R1234yf | mass % | 15.0 | 5.0 | 5.0 |
| R1234ze | mass % | 10.0 | 20.0 | 10.0 |
| GWP | — | 474 | 474 | 541 |
| COP ratio | % (relative to | 101.2 | 101.6 | 101.3 |
| | R410A) | | | |
| Refrigerating | % (relative to | 102.4 | 100.7 | 107.0 |
| capacity ratio | R410A) | | | |
| Condensation | ° C. | 3.7 | 4.7 | 3.1 |
| temperature glide | | | | |

TABLE 14

| | | Comp. | Comp. | Comp. | Comp. | Comp. | Comp. | Comp. | Comp. |
|---|---|---|---|---|---|---|---|---|---|
| Hten | Unit | Ex. 144 | Ex. 145 | Ex. 146 | Ex. 147 | Ex. 148 | Ex. 149 | Ex. 150 | Ex. 151 |
| HFO-1132a | mass % | 7.5 | 7.5 | 7.5 | 7.5 | 7.5 | 7.5 | 7.5 | 7.5 |
| R32 | mass % | 10.0 | 10.0 | 10.0 | 10.0 | 10.0 | 10.0 | 10.0 | 10.0 |
| R1234yf | mass % | 72.5 | 62.5 | 52.5 | 42.5 | 32.5 | 22.5 | 12.5 | 2.5 |
| R1234zł | mass % | 10.0 | 20.0 | 30.0 | 40.0 | 50.0 | 60.0 | 70.0 | 80.0 |
| GWP | — | 71 | 71 | 71 | 72 | 72 | 72 | 72 | 72 |
| COP ratio | % (relative to | 102.5 | 102.7 | 102.9 | 103.1 | 103.3 | 103.4 | 103.5 | 103.6 |
| | R410A) | | | | | | | | |
| Refrigerating | % (relative to | 63.9 | 63.3 | 62.5 | 61.8 | 61.0 | 60.1 | 59.3 | 58.5 |
| capacity ratio | R410A) | | | | | | | | |
| Condensation | ° C. | 12.4 | 13.3 | 14.4 | 15.6 | 16.9 | 18.4 | 20.1 | 21.8 |
| temperature glide | | | | | | | | | |
| | | | | | Comp. | Comp. | Comp. | | |
| Item | Unit | Ex. 132 | Ex. 133 | Ex. 134 | Ex. 152 | Ex. 153 | Ex. 154 | Ex. 135 | Ex. 136 |
| HFO-11323 | mass % | 7.5 | 7.5 | 7.5 | 7.5 | 7.5 | 7.5 | 7.5 | 7.5 |
| R32 | mass % | 20.0 | 20.0 | 20.0 | 20.0 | 20.0 | 20.0 | 30.0 | 30.0 |
| R1234yf | mass % | 62.5 | 52.5 | 42.5 | 22.5 | 12.5 | 2.5 | 52.5 | 42.5 |
| R1234ze | mass % | 10.0 | 20.0 | 30.0 | 50.0 | 60.0 | 70.0 | 30.0 | 20.0 |
| GWP | — | 138 | 138 | 139 | 139 | 139 | 139 | 205 | 205 |
| COP ratio | % (relative to | 101.7 | 102.0 | 102.4 | 103.2 | 103.5 | 103.8 | 100.8 | 101.2 |
| | R410A) | | | | | | | | |
| Refrigerating | 9% (relative to | 73.4 | 72.5 | 71.6 | 69.6 | 68.6 | 67.6 | 81.4 | 80.3 |
| capacity ratio | R410A) | | | | | | | | |
| Condensation | ° C. | 11.2 | 12.2 | 13.3 | 15.9 | 17.4 | 19.0 | 9.3 | 10.4 |
| temperature glide | | | | | | | | | |
| Item | Unit | Ex. 137 | Ex. 138 | Ex. 139 | Ex. 140 | Ex. 141 | Ex. 142 | Ex. 143 | Ex. 144 |
| HFO-1132a | mass % | 7.5 | 7.5 | 7.5 | 7.5 | 7.5 | 7.5 | 7.5 | 7.5 |
| R32 | mass % | 30.0 | 30.0 | 30.0 | 30.0 | 40.0 | 40.0 | 40.0 | 40.0 |
| R1234yf | mass % | 32.5 | 22.5 | 12.5 | 2.5 | 42.5 | 32.5 | 22.5 | 12.5 |
| R1234ze | mass % | 30.0 | 40.0 | 50.0 | 60.0 | 10.0 | 20.0 | 30.0 | 40.0 |
| GWP | — | 206 | 206 | 206 | 206 | 272 | 273 | 273 | 273 |
| COP ratio | % (relative to | 101.7 | 102.1 | 102.6 | 103.1 | 100.4 | 100.8 | 101.2 | 101.7 |
| | R410A) | | | | | | | | |
| Refrigerating | % (relative to | 79.1 | 78.0 | 76.8 | 75.6 | 88.5 | 87.2 | 85.9 | 84.5 |
| capacity ratio | R410A) | | | | | | | | |
| Condensation | ° C. | 11.6 | 13.0 | 14.4 | 15.9 | 7.6 | 8.7 | 10.0 | 11.4 |
| temperature glide | | | | | | | | | |
| Item | Unit | Ex. 145 | Ex. 146 | Ex. 147 | Ex. 148 | Ex. 149 | Ex. 150 | Ex. 151 | Ex. 152 |
| HFO-1132a | mass % | 7.5 | 7.5 | 7.5 | 7.5 | 7.5 | 7.5 | 7.5 | 7.5 |
| R32 | mass % | 40.0 | 50.0 | 50.0 | 50.0 | 50.0 | 60.0 | 60.0 | 60.0 |
| R1234yf | mass % | 2.5 | 32.5 | 22.5 | 12.5 | 2.5 | 22.5 | 12.5 | 2.5 |
| R1234ze | mass % | 50.0 | 10.0 | 20.0 | 30.0 | 40.0 | 10.0 | 20.0 | 30.0 |
| GWP | — | 273 | 339 | 340 | 340 | 340 | 407 | 407 | 407 |
| COP ratio | % (relative to | 102.2 | 100.3 | 100.7 | 101.1 | 101.5 | 100.4 | 100.7 | 101.1 |
| | R410A) | | | | | | | | |
| Refrigerating | % (relative to | 83.1 | 95.0 | 93.5 | 91.9 | 90.4 | 100.7 | 99.1 | 97.4 |
| capacity ratio | R410A) | | | | | | | | |
| Condensation | ° C. | 12.8 | 6.2 | 7.3 | 8.6 | 10.0 | 5.1 | 6.3 | 7.5 |
| temperature glide | | | | | | | | | |

| | | | | Comp. |
|---|---|---|---|---|
| Item | Unit | Ex. 153 | Ex. 154 | Ex. 155 |
| HFO-11328 | mass % | 7.5 | 7.5 | 7.5 |
| ER32 | mass % | 70.0 | 70.0 | 80.0 |
| R1234yf | mass % | 12.5 | 2.5 | 2.5 |
| R1234ze | mass % | 10.0 | 20.0 | 10.0 |
| GWP | — | 474 | 474 | 541 |
| COP ratio | % (relative to | 100.5 | 100.8 | 100.6 |
| | R410A) | | | |
| Refrigerating | % (relative to | 105.7 | 104.1 | 110.2 |
| capacity ratio | R410A) | | | |
| Condensation | ° C. | 4.3 | 5.4 | 3.7 |
| temperature glide | | | | |

TABLE 15

| | | Comp. | Comp. | Comp. | Comp. | Comp. | Comp. | Comp. | |
|---|---|---|---|---|---|---|---|---|---|
| Item | Unit | Ex. 156 | Ex. 157 | Ex. 158 | Ex. 159 | Ex. 160 | Ex. 161 | Ex. 162 | Ex. 155 |
| HFO-1132a | mass % | 10.0 | 10.0 | 10.0 | 10.0 | 10.0 | 10.0 | 10.0 | 10.0 |
| R32 | mass % | 10.0 | 10.0 | 10.0 | 10.0 | 10.0 | 10.0 | 10.0 | 20.0 |
| R1234yf | mass % | 70.0 | 60.0 | 50.0 | 40.0 | 30.0 | 20.0 | 10.0 | 60.0 |
| R1234ze | mass % | 10.0 | 20.0 | 30.0 | 40.0 | 50.0 | 60.0 | 70.0 | 10.0 |
| GWP | — | 71 | 71 | 71 | 72 | 72 | 72 | 72 | 138 |
| COP ratio | % (relative | 101.9 | 102.1 | 102.3 | 102.5 | 102.7 | 102.9 | 103.0 | 101.0 |
| | to R410A) | | | | | | | | |
| Refrigerating | % (relative | 67.5 | 66.9 | 66.2 | 65.5 | 64.9 | 64.2 | 63.5 | 76.8 |
| capacity ratio | to R410A) | | | | | | | | |
| Condensation | ° C. | 13.6 | 14.7 | 15.9 | 17.3 | 18.8 | 20.5 | 22.3 | 12.0 |
| temperature glide | | | | | | | | | |
| Item | Unit | Ex. 156 | Ex. 157 | Ex. 158 | Ex. 159 | Ex. 160 | Ex. 161 | Ex. 162 | Ex. 163 |
| HFO-1132a | mass % | 10.0 | 10.0 | 10.0 | 10.0 | 10.0 | 10.0 | 10.0 | 10.0 |
| R32 | mass % | 20.0 | 20.0 | 20.0 | 20.0 | 20.0 | 30.0 | 30.0 | 30.0 |
| R1234yf | mass % | 50.0 | 40.0 | 30.0 | 20.0 | 10.0 | 50.0 | 40.0 | 30.0 |
| R1234ze | mass % | 20.0 | 30.0 | 40.0 | 50.0 | 60.0 | 10.0 | 20.0 | 30.0 |
| GWP | — | 138 | 139 | 139 | 139 | 139 | 205 | 205 | 206 |
| COP ratio | % (relative | 101.3 | 101.7 | 102.0 | 102.4 | 102.8 | 100.0 | 100.4 | 100.9 |
| | to R410A) | | | | | | | | |
| Refrigerating | % (relative | 76.0 | 75.1 | 74.2 | 73.3 | 72.4 | 84.7 | 83.7 | 82.6 |
| capacity ratio | to R410A) | | | | | | | | |
| Condensation | ° C. | 13.1 | 14.4 | 15.8 | 17.3 | 18.9 | 10.0 | 11.2 | 12.5 |
| temperature glide | | | | | | | | | |
| Item | Unit | Ex. 164 | Ex. 165 | Ex. 166 | Ex. 167 | Ex. 168 | Ex. 169 | Ex. 170 | Ex. 171 |
| HFO-1132a | mass % | 10.0 | 10.0 | 10.0 | 10.0 | 10.0 | 10.0 | 10.0 | 10.0 |
| R32 | mass % | 30.0 | 30.0 | 40.0 | 40.0 | 40.0 | 40.0 | 50.0 | 50.0 |
| R1234yf | mass % | 20.0 | 10.0 | 40.0 | 30.0 | 20.0 | 10.0 | 30.0 | 20.0 |
| R1234ze | mass % | 40.0 | 50.0 | 10.0 | 20.0 | 30.0 | 40.0 | 10.0 | 20.0 |
| GWP | — | 206 | 206 | 272 | 273 | 273 | 273 | 339 | 340 |
| COP ratio | % (relative | 101.3 | 101.8 | 99.6 | 100.0 | 100.4 | 100.9 | 99.6 | 99.9 |
| | to R410A) | | | | | | | | |
| Refrigerating | % (relative | 81.5 | 80.4 | 91.8 | 90.6 | 89.3 | 87.9 | 98.2 | 96.8 |
| capacity ratio | to R410A) | | | | | | | | |
| Condensation | ° C. | 13.9 | 15.5 | 8.1 | 9.4 | 10.8 | 12.2 | 6.7 | 8.0 |
| temperature glide | | | | | | | | | |

| | | | | | | Comp. |
|---|---|---|---|---|---|---|
| Item | Unit | Ex. 172 | Ex. 173 | Ex. 174 | Ex. 175 | Ex. 163 |
| HFO-1132a | mass % | 10.0 | 10.0 | 10.0 | 10.0 | 10.0 |
| R32 | mass % | 50.0 | 60.0 | 60.0 | 70.0 | 80.0 |
| R1234yf | mass % | 10.0 | 20.0 | 10.0 | 10.0 | 5.0 |
| R1234ze | mass % | 30.0 | 10.0 | 20.0 | 10.0 | 5.0 |
| GWP | — | 340 | 407 | 407 | 474 | 541 |
| COP ratio | % (relative | 100.3 | 99.7 | 100.0 | 99.8 | 99.8 |
| | to R410A) | | | | | |
| Refrigerating | % (relative | 95.3 | 103.9 | 102.4 | 108.9 | 114.1 |
| capacity ratio | to R410A) | | | | | |
| Condensation | ° C. | 9.3 | 5.6 | 6.9 | 4.9 | 3.7 |
| temperature glide | | | | | | |

TABLE 16

| | | Comp. | Comp. | Comp. | Comp. | Comp. | | Comp. | Comp. |
|---|---|---|---|---|---|---|---|---|---|
| Item | Unit | Ex. 164 | Ex. 165 | Ex. 166 | Ex. 167 | Ex. 168 | Ex. 176 | Ex. 169 | Ex. 170 |
| HFO-1132a | mass % | 10.0 | 12.5 | 7.5 | 12.5 | 6.3 | 8.8 | 11.3 | 4.0 |
| R32 | mass % | 10.0 | 10.0 | 12.5 | 12.5 | 15.0 | 15.0 | 15.0 | 17.5 |
| R1234yf | mass % | 0.0 | 0.0 | 0.0 | 0.0 | 0.0 | 0.0 | 0.0 | 0.0 |
| R1234ze | mass % | 80.0 | 77.5 | 80.0 | 75.0 | 78.8 | 76.3 | 73.8 | 78.5 |
| GWP | — | 72 | 72 | 89 | 89 | 106 | 106 | 106 | 123 |
| COP ratio | % (relative to | 105.6 | 103.9 | 107.4 | 104.1 | 108.4 | 106.7 | 105.2 | 110.1 |
| | R404A) | | | | | | | | |
| Refrigerating | % (relative to | 66.0 | 70.0 | 65.9 | 74.2 | 67.7 | 72.0 | 76.4 | 67.6 |
| capacity ratio | R404A) | | | | | | | | |
| Condensation | ° C. | 25.5 | 26.9 | 22.6 | 25.8 | 20.6 | 22.8 | 24.2 | 17.5 |
| temperature glide | | | | | | | | | |
| | | | | Comp. | Comp. | | | | Comp. |
| Item | Unit | Ex. 177 | Ex. 178 | Ex. 171 | Ex. 172 | Ex. 179 | Ex. 180 | Ex. 181 | Ex. 173 |
| HFO-1132a | mass % | 6.5 | 9.0 | 11.5 | 1.5 | 4.0 | 6.5 | 9.0 | 11.5 |
| R32 | mass % | 17.5 | 17.5 | 17.5 | 20.0 | 20.0 | 20.0 | 20.0 | 20.0 |
| R1234yf | mass % | 0.0 | 0.0 | 0.0 | 0.0 | 0.0 | 0.0 | 0.0 | 0.0 |
| R1234ze | mass % | 76.0 | 73.5 | 71.0 | 78.5 | 76.0 | 73.5 | 71.0 | 68.5 |
| GWP | — | 123 | 123 | 123 | 140 | 140 | 139 | 139 | 139 |
| COP ratio | % (relative to | 108.4 | 106.8 | 105.2 | 112.0 | 110.2 | 108.6 | 107.0 | 105.5 |
| | R404A) | | | | | | | | |
| Refrigerating | % (relative to | 72.1 | 76.6 | 81.2 | 67.0 | 71.6 | 76.2 | 80.9 | 85.6 |
| capacity ratio | R404A) | | | | | | | | |
| Condensation | ° C. | 20.2 | 22.1 | 23.3 | 13.6 | 17.0 | 19.5 | 21.2 | 22.3 |
| temperature glide | | | | | | | | | |

| | | Comp. | Comp. | Comp. | Comp. | Comp. |
|---|---|---|---|---|---|---|
| Item | Unit | Ex. 174 | Ex. 178 | Ex. 176 | Ex. 177 | Ex. 178 |
| HFO-1132a | mass % | 1.5 | 4.0 | 6.5 | 9.0 | 11.5 |
| R32 | mass % | 22.5 | 22.5 | 22.5 | 22.5 | 22.5 |
| R1234yf | mass % | 0.0 | 0.0 | 0.0 | 0.0 | 0.0 |
| R1234ze | mass % | 76.0 | 73.5 | 71.0 | 68.5 | 66.0 |
| GWP | — | 156 | 156 | 156 | 156 | 156 |
| COP ratio | % (relative to | 112.1 | 110.3 | 108.7 | 107.1 | 105.6 |
| | R404A) | | | | | |
| Refrigerating | % (relative to | 70.8 | 75.6 | 80.3 | 85.1 | 90.0 |
| capacity ratio | R404A) | | | | | |
| Condensation | ° C. | 13.4 | 16.5 | 18.8 | 20.3 | 21.3 |
| temperature glide | | | | | | |

TABLE 17

| | | | Comp. | Comp. | | | | Comp. | Comp. |
|---|---|---|---|---|---|---|---|---|---|
| Item | Unit | Ex. 182 | Ex. 179 | Ex. 180 | Ex. 183 | Ex. 184 | Ex. 185 | Ex. 181 | Ex. 182 |
| HFO-1132a | mass % | 1.5 | 1.5 | 1.5 | 1.5 | 1.5 | 1.5 | 1.5 | 1.5 |
| R32 | mass % | 10.0 | 10.0 | 10.0 | 15.0 | 15.0 | 15.0 | 15.0 | 15.0 |
| R1234yf | mass % | 83.5 | 73.5 | 63.5 | 78.5 | 68.5 | 58.5 | 38.5 | 28.5 |
| R1234ze | mass % | 5.0 | 15.0 | 25.0 | 5.0 | 15.0 | 25.0 | 45.0 | 55.0 |
| GWP | — | 71 | 71 | 72 | 105 | 105 | 105 | 106 | 106 |
| COP ratio | % (relative to | 106.9 | 107.4 | 108.0 | 107.3 | 107.8 | 108.3 | 109.5 | 110.0 |
| | R404A) | | | | | | | | |
| Refrigerating | % (relative to | 70.9 | 68.7 | 66.5 | 79.2 | 76.7 | 74.2 | 69.1 | 66.5 |
| capacity ratio | R404A) | | | | | | | | |
| Condensation | ° C. | 8.1 | 8.5 | 9.0 | 8.4 | 8.9 | 9.5 | 10.8 | 11.5 |
| temperature glide | | | | | | | | | |
| | | | | | | | | Comp. | Comp. |
| Item | Unit | Ex. 186 | Ex. 187 | Ex. 188 | Ex. 189 | Ex. 190 | Ex. 191 | Ex. 183 | Ex. 184 |
| HFO-1132a | mass % | 1.5 | 1.5 | 1.5 | 1.5 | 1.5 | 1.5 | 1.5 | 1.5 |
| R32 | mass % | 20.0 | 20.0 | 20.0 | 20.0 | 20.0 | 20.0 | 20.0 | 25.0 |
| R1234yf | mass % | 73.5 | 63.5 | 53.5 | 43.5 | 33.5 | 23.5 | 3.5 | 68.5 |
| R1234ze | mass % | 5.0 | 15.0 | 25.0 | 35.0 | 45.0 | 55.0 | 75.0 | 5.0 |
| GWP | — | 138 | 138 | 139 | 139 | 139 | 139 | 140 | 172 |
| COP ratio | % (relative to | 107.6 | 108.1 | 108.7 | 109.3 | 109.9 | 110.5 | 111.7 | 107.8 |
| | R404A) | | | | | | | | |
| Refrigerating | % (relative to | 87.4 | 84.7 | 81.9 | 79.1 | 76.2 | 73.4 | 67.9 | 95.4 |
| capacity ratio | R404A) | | | | | | | | |
| Condensation | ° C. | 8.2 | 8.8 | 9.4 | 10.2 | 10.9 | 11.7 | 13.3 | 7.6 |
| temperature glide | | | | | | | | | |

| | | Comp. | Comp. | Comp. | Comp. | Comp. | Comp. |
|---|---|---|---|---|---|---|---|
| Item | Unit | Ex. 185 | Ex. 186 | Ex. 187 | Ex. 188 | Ex. 189 | Ex. 190 |
| HFO-1132a | mass % | 1.5 | 1.5 | 1.5 | 1.5 | 1.5 | 1.5 |
| R32 | mass % | 25.0 | 25.0 | 25.0 | 25.0 | 25.0 | 25.0 |
| R1234yf | mass % | 58.5 | 48.5 | 38.5 | 28.5 | 18.5 | 8.5 |
| R1234ze | mass % | 15.0 | 25.0 | 35.0 | 45.0 | 55.0 | 65.0 |
| GWP | — | 172 | 172 | 172 | 173 | 173 | 173 |
| COP ratio | % (relative to | 108.4 | 109.1 | 109.7 | 110.3 | 111.0 | 111.6 |
| | R404A) | | | | | | |
| Refrigerating | % (relative to | 92.5 | 89.4 | 86.3 | 83.2 | 80.2 | 77.2 |
| capacity ratio | R404A) | | | | | | |
| Condensation | ° C. | 8.2 | 9.0 | 9.8 | 10.7 | 11.5 | 12.4 |
| temperature glide | | | | | | | |

TABLE 18

| | | | Comp. | Comp. | | | | Comp. | Comp. |
|---|---|---|---|---|---|---|---|---|---|
| Item | Unit | Ex. 192 | Ex. 191 | Ex. 192 | Ex.193 | Ex.194 | Ex.195 | Ex. 193 | Ex. 194 |
| HFO-1132a | mass % | 1.9 | 1.9 | 1.9 | 1.9 | 1.9 | 1.9 | 1.9 | 1.9 |
| R32 | mass % | 10.0 | 10.0 | 10.0 | 15.0 | 15.0 | 15.0 | 15.0 | 15.0 |
| R1234yf | mass % | 83.1 | 73.1 | 63.1 | 78.1 | 68.1 | 58.1 | 38.1 | 28.1 |
| R1234ze | mass % | 5.0 | 15.0 | 25.0 | 5.0 | 15.0 | 25.0 | 45.0 | 55.0 |
| GWP | — | 71 | 71 | 72 | 105 | 105 | 105 | 105 | 106 |
| COP ratio | % (relative to | 106.8 | 107.3 | 107.8 | 107.1 | 107.6 | 108.2 | 109.3 | 109.8 |
| | R404A) | | | | | | | | |
| Refrigerating | % (relative to | 71.5 | 69.4 | 67.2 | 79.9 | 77.4 | 74.9 | 69.7 | 67.1 |
| capacity ratio | R404A) | | | | | | | | |
| Condensation | ° C. | 8.4 | 8.9 | 9.4 | 8.7 | 9.3 | 9.9 | 11.3 | 12.1 |
| temperature glide | | | | | | | | | |
| | | | | | | | | Comp. | Comp. |
| Item | Unit | Ex. 196 | Ex. 197 | Ex. 198 | Ex. 199 | Ex. 200 | Ex. 201 | Ex. 195 | Ex. 196 |
| HFO-1132a | mass % | 1.9 | 1.9 | 1.9 | 1.9 | 1.9 | 1.9 | 1.9 | 1.9 |
| R32 | mass % | 20.0 | 20.0 | 20.0 | 20.0 | 20.0 | 20.0 | 20.0 | 25.0 |
| R1234yf | mass % | 73.1 | 63.1 | 53.1 | 43.1 | 33.1 | 23.1 | 3.1 | 68.1 |
| R1234ze | mass % | 5.0 | 15.0 | 25.0 | 35.0 | 45.0 | 55.0 | 75.0 | 5.0 |
| GWP | — | 138 | 138 | 139 | 139 | 139 | 139 | 140 | 172 |
| COP ratio | % (relative to | 107.4 | 108.0 | 108.5 | 109.1 | 109.7 | 110.3 | 111.5 | 107.7 |
| | R404A) | | | | | | | | |
| Refrigerating | % (relative to | 88.1 | 85.4 | 82.6 | 79.7 | 76.9 | 74.1 | 68.5 | 96.2 |
| capacity ratio | R404A) | | | | | | | | |
| Condensation | ° C. | 8.4 | 9.0 | 9.8 | 10.5 | 11.3 | 12.2 | 13.9 | 7.8 |
| temperature glide | | | | | | | | | |

| | | Comp. | Comp. | Comp. | Comp. | Comp. | Comp. |
|---|---|---|---|---|---|---|---|
| Item | Unit | Ex. 197 | Ex. 198 | Ex. 199 | Ex. 200 | Ex. 201 | Ex. 202 |
| HFO-1132a | mass % | 1.9 | 1.9 | 1.9 | 1.9 | 1.9 | 1.9 |
| R32 | mass % | 25.0 | 25.0 | 25.0 | 25.0 | 25.0 | 25.0 |
| R1234yf | mass % | 58.1 | 48.1 | 38.1 | 28.1 | 18.1 | 8.1 |
| R1234ze | mass % | 15.0 | 25.0 | 35.0 | 45.0 | 55.0 | 65.0 |
| GWP | — | 172 | 172 | 172 | 173 | 173 | 173 |
| COP ratio | % (relative to | 108.3 | 108.9 | 109.5 | 110.1 | 110.7 | 111.4 |
| | R404A) | | | | | | |
| Refrigerating | % (relative to | 93.2 | 90.1 | 87.0 | 83.9 | 80.9 | 77.9 |
| capacity ratio | R404A) | | | | | | |
| Condensation | ° C. | 8.5 | 9.3 | 10.2 | 11.0 | 12.0 | 12.9 |
| temperature glide | | | | | | | |

TABLE 19

| | | | | | Comp. | Comp. | | | |
|---|---|---|---|---|---|---|---|---|---|
| Item | Unit | Ex. 202 | Ex. 203 | Ex. 204 | Ex. 203 | Ex. 204 | Ex. 205 | Ex. 206 | Ex. 207 |
| HFO-1132a | mass % | 6.0 | 6.0 | 6.0 | 6.0 | 6.0 | 6.0 | 6.0 | 6.0 |
| R32 | mass % | 10.0 | 10.0 | 10.0 | 10.0 | 10.0 | 15.0 | 15.0 | 15.0 |
| R1234yf | mass % | 79.0 | 69.0 | 59.0 | 39.0 | 29.0 | 74.0 | 64.0 | 54.0 |
| R1234ze | mass % | 5.0 | 15.0 | 25.0 | 45.0 | 55.0 | 5.0 | 15.0 | 25.0 |
| GWP | — | 71 | 71 | 71 | 72 | 72 | 105 | 105 | 105 |
| COP ratio | % (relative to | 105.6 | 105.9 | 106.2 | 106.9 | 107.2 | 105.8 | 106.1 | 106.5 |
| | R410A) | | | | | | | | |
| Refrigerating | % (relative to | 78.5 | 76.2 | 73.8 | 68.9 | 66.5 | 87.2 | 84.6 | 81.9 |
| capacity ratio | R410A) | | | | | | | | |
| Condensation | ° C. | 11.6 | 12.4 | 13.3 | 15.6 | 17.0 | 11.3 | 12.2 | 13.1 |
| temperature glide | | | | | | | | | |
| | | | | | Comp. | | | | |
| Item | Unit | Ex. 208 | Ex. 209 | Ex. 210 | Ex. 205 | Ex. 211 | Ex. 212 | Ex. 213 | Ex. 214 |
| HFO-1132a | mass % | 6.0 | 6.0 | 6.0 | 6.0 | 6.0 | 6.0 | 6.0 | 6.0 |
| R32 | mass % | 15.0 | 15.0 | 15.0 | 15.0 | 20.0 | 20.0 | 20.0 | 20.0 |
| R1234yf | mass % | 44.0 | 34.0 | 24.0 | 4.0 | 69.0 | 59.0 | 49.0 | 39.0 |
| R1234ze | mass % | 35.0 | 45.0 | 55.0 | 75.0 | 5.0 | 15.0 | 25.0 | 35.0 |
| GWP | — | 105 | 105 | 106 | 106 | 138 | 138 | 139 | 139 |
| COP ratio | % (relative to | 106.9 | 107.2 | 107.6 | 108.4 | 106.0 | 106.4 | 106.8 | 107.2 |
| | R410A) | | | | | | | | |
| Refrigerating | % (relative to | 79.1 | 76.4 | 73.6 | 68.3 | 95.7 | 92.9 | 89.9 | 86.8 |
| capacity ratio | R410A) | | | | | | | | |
| Condensation | ° C. | 14.3 | 15.5 | 16.8 | 19.7 | 10.6 | 11.5 | 12.6 | 13.7 |
| temperature glide | | | | | | | | | |
| | | | | | Comp. | Comp. | Comp. | Comp. | Comp. |
| Item | Unit | Ex. 215 | Ex. 216 | Ex. 217 | Ex. 206 | Ex. 207 | Ex. 208 | Ex. 209 | Ex. 210 |
| HFO-1132a | mass % | 6.0 | 6.0 | 6.0 | 6.0 | 6.0 | 6.0 | 6.0 | 6.0 |
| R32 | mass % | 20.0 | 20.0 | 20.0 | 25.0 | 25.0 | 25.0 | 25.0 | 25.0 |
| R1234yf | mass % | 29.0 | 19.0 | 9.0 | 64.0 | 54.0 | 44.0 | 34.0 | 24.0 |
| R1234ze | mass % | 45.0 | 55.0 | 65.0 | 5.0 | 15.0 | 25.0 | 35.0 | 45.0 |
| GWP | — | 139 | 139 | 139 | 172 | 172 | 172 | 172 | 172 |
| COP ratio | % (relative to | 107.6 | 108.1 | 108.5 | 106.2 | 106.6 | 107.0 | 107.5 | 108.0 |
| | R410A) | | | | | | | | |
| Refrigerating | % (relative to | 83.8 | 80.8 | 77.9 | 104.0 | 100.8 | 97.6 | 94.3 | 91.0 |
| capacity ratio | R410A) | | | | | | | | |
| Condensation | ° C. | 15.0 | 16.3 | 17.7 | 9.7 | 10.7 | 11.8 | 13.0 | 14.3 |
| temperature glide | | | | | | | | | |

| | | Comp. | Comp. |
|---|---|---|---|
| Item | Unit | Ex. 211 | Ex. 212 |
| HFO-1132a | mass % | 6.0 | 6.0 |
| R32 | mass % | 25.0 | 25.0 |
| R1234yf | mass % | 14.0 | 4.0 |
| R1234ze | mass % | 55.0 | 65.0 |
| GWF | — | 173 | 173 |
| COP ratio | % (relative to | 108.5 | 108.9 |
| | R410A) | | |
| Refrigerating | % (relative to | 87.8 | 84.7 |
| capacity ratio | | | |
| | R410A) | | |
| Condensation | ° C. | 15.6 | 17.1 |
| temperature glide | | | |

TABLE 20

| | | | | | Comp. | Comp. | | | |
|---|---|---|---|---|---|---|---|---|---|
| Item | Unit | Ex. 218 | Ex. 219 | Ex. 220 | Ex. 213 | Ex. 214 | Ex. 221 | Ex. 222 | Ex. 223 |
| HFO-1132a | mass % | 10.0 | 10.0 | 10.0 | 10.0 | 10.0 | 10.0 | 10.0 | 10.0 |
| R32 | mass % | 5.0 | 5.0 | 5.0 | 5.0 | 5.0 | 10.0 | 10.0 | 10.0 |
| R1234yf | mass % | 80.0 | 70.0 | 60.0 | 40.0 | 30.0 | 75.0 | 65.0 | 55.0 |
| R1234ze | mass % | 5.0 | 15.0 | 25.0 | 45.0 | 55.0 | 5.0 | 15.0 | 25.0 |
| GWP | — | 37 | 38 | 38 | 38 | 38 | 71 | 71 | 71 |
| COP ratio | % (relative to | 104.3 | 104.4 | 104.4 | 104.6 | 104.8 | 104.4 | 104.5 | 104.6 |
| | R410A) | | | | | | | | |
| Refrigerating | % (relative to | 76.5 | 74.4 | 72.2 | 67.6 | 65.2 | 85.6 | 83.1 | 80.6 |
| capacity ratio | R410A) | | | | | | | | |
| Condensation | ° C. | 13.8 | 14.9 | 16.2 | 19.2 | 20.9 | 13.8 | 14.8 | 16.0 |
| temperature glide | | | | | | | | | |
| | | | | | Comp. | | | | |
| Item | Unit | Ex. 224 | Ex. 225 | Ex. 226 | Ex. 215 | Ex. 227 | Ex. 228 | Ex. 229 | Ex. 230 |
| HFO-1132a | mass % | 10.0 | 10.0 | 10.0 | 10.0 | 10.0 | 10.0 | 10.0 | 10.0 |
| R32 | mass % | 10.0 | 10.0 | 10.0 | 10.0 | 15.0 | 15.0 | 15.0 | 15.0 |
| R1234yf | mass % | 45.0 | 35.0 | 25.0 | 5.0 | 70.0 | 60.0 | 50.0 | 40.0 |
| R1234ze | mass % | 35.0 | 45.0 | 55.0 | 75.0 | 5.0 | 15.0 | 25.0 | 35.0 |
| GWP | — | 72 | 72 | 72 | 72 | 104 | 105 | 105 | 105 |
| COP ratio | % (relative to | 104.7 | 104.9 | 105.1 | 105.5 | 104.5 | 104.7 | 104.8 | 105.0 |
| | R410A) | | | | | | | | |
| Refrigerating | % (relative to | 77.9 | 75.2 | 72.5 | 67.3 | 94.6 | 91.9 | 89.0 | 86.0 |
| capacity ratio | R410A) | | | | | | | | |
| Condensation | ° C. | 17.4 | 18.9 | 20.6 | 24.4 | 13.1 | 14.2 | 15.4 | 16.7 |
| temperature glide | | | | | | | | | |
| Item | Unit | Ex. 231 | Ex. 232 | Ex. 233 | Ex. 234 | Ex. 235 | Ex. 236 | Ex. 237 | Ex. 238 |
| HFO-1132a | mass % | 10.0 | 10.0 | 10.0 | 10.0 | 10.0 | 10.0 | 10.0 | 10.0 |
| R32 | mass % | 15.0 | 15.0 | 15.0 | 20.0 | 20.0 | 20.0 | 20.0 | 20.0 |
| R1234yf | mass % | 30.0 | 20.0 | 10.0 | 65.0 | 55.0 | 45.0 | 35.0 | 25.0 |
| R1234ze | mass % | 45.0 | 55.0 | 65.0 | 5.0 | 15.0 | 25.0 | 35.0 | 45.0 |
| GWP | — | 105 | 105 | 106 | 138 | 138 | 138 | 139 | 139 |
| COP ratio | % (relative to | 105.3 | 105.5 | 105.7 | 104.6 | 104.8 | 105.1 | 105.3 | 105.6 |
| | R410A) | | | | | | | | |
| Refrigerating | % (relative to | 83.0 | 80.0 | 77.1 | 103.4 | 100.4 | 97.2 | 93.9 | 90.7 |
| capacity ratio | R410A) | | | | | | | | |
| Condensation | ° C. | 18.2 | 19.9 | 21.6 | 12.1 | 13.2 | 14.5 | 15.8 | 17.3 |
| temperature glide | | | | | | | | | |
| | | | | Comp. | Comp. | Comp. | Comp. | Comp. | Comp. |
| Item | Unit | Ex. 239 | Ex. 240 | Ex. 216 | Ex. 217 | Ex. 218 | Ex. 219 | Ex. 220 | Ex. 221 |
| HFO-1132a | mass % | 10.0 | 10.0 | 10.0 | 10.0 | 10.0 | 10.0 | 10.0 | 10.0 |
| R32 | mass % | 20.0 | 20.0 | 25.0 | 25.0 | 25.0 | 25.0 | 25.0 | 25.0 |
| R1234yf | mass % | 15.0 | 5.0 | 60.0 | 50.0 | 40.0 | 30.0 | 20.0 | 10.0 |
| R1234ze | mass % | 55.0 | 65.0 | 5.0 | 15.0 | 25.0 | 35.0 | 45.0 | 55.0 |
| GWP | — | 139 | 139 | 172 | 172 | 172 | 172 | 172 | 173 |
| COP ratio | % (relative to | 105.9 | 106.2 | 104.7 | 105.0 | 105.3 | 105.6 | 105.9 | 106.3 |
| | R410A) | | | | | | | | |
| Refrigerating | % (relative to | 87.5 | 84.3 | 111.9 | 108.5 | 105.0 | 101.5 | 98.1 | 94.6 |
| capacity ratio | R410A) | | | | | | | | |
| Condensation | ° C. | 19.0 | 20.7 | 11.0 | 12.2 | 13.5 | 14.9 | 16.4 | 18.0 |
| temperature glide | | | | | | | | | |

1-23. (canceled)

24. A composition comprising a refrigerant, the refrigerant comprising 1,1-difluoroethylene (HFO-1132a), difluoromethane (R32), and 1,3,3,3-tetrafluoropropene (R1234ze) in a total amount of 99.5 mass % or more based on the entire refrigerant,
wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines IB, BE, EF, and FI that connect the following four points:
point I (10.0, 74.0, 16.0),
point B (1.5, 73.9, 24.6),
point E (1.5, 56.2, 42.3), and
point F (10.0, 37.7, 52.3),
or on the straight lines.

25. A composition comprising a refrigerant, the refrigerant comprising HFO-1132a, R32, and R1234ze in a total amount of 99.5 mass % or more based on the entire refrigerant,
wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines G′B, BG, and GG′ that connect the following three points:
point G′ (8.6, 73.9, 17.5),
point B (1.5, 73.9, 24.6), and
point G (1.5, 65.9, 32.6),
or on the straight lines.

26. A composition comprising a refrigerant, the refrigerant comprising HFO-1132a, R32, and R1234ze in a total amount of 99.5 mass % or more based on the entire refrigerant,
wherein
when the mass % of HFO-1132a, R32, and R1234ze based on their sum in the refrigerant is respectively represented by x, y, and z, coordinates (x,y,z) in a ternary composition diagram in which the sum of HFO-1132a, R32, and R1234ze is 100 mass % are within the range of a figure surrounded by straight lines JB′, B′E, EF, and FJ that connect the following four points:
point J (10.0, 59.0, 31.0),
point B′ (1.5, 58.9, 39.6),
point E (1.5, 56.2, 42.3), and
point F (10.0, 37.7, 52.3),
or on the straight lines.

27. A composition comprising a refrigerant, the refrigerant comprising HFO-1132a, R32, R1234ze, and 2,3,3,3-tetrafluoro-1-propene (R1234yf) in a total amount of 99.5 mass % or more based on the entire refrigerant,
wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines AB, BC, CD, and DA that connect the following four points:
point A (74.0, −a+26.0, 0.0),
point B (73.9, 0.0, −a+26.1),
point D (0.0098a²−2.1856a+39.064, 0.0, −0.0098a²+1.1856a+60.936), and
point C (0.0138a²−1.6252a+26.785, −0.0138a²+0.6252a+73.215, 0.0),
or on the straight lines AB and CD (excluding the points A, B, C, and D).

28. A composition comprising a refrigerant, the refrigerant comprising HFO-1132a, R32, R1234ze, and R1234yf in a total amount of 99.5 mass % or more based on the entire refrigerant,
wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines AB, BF, FE, and EA that connect the following four points:
point A (74.0, −a+26.0, 0.0),
point B (73.9, 0.0, −a+26.1),
point F (0.0102a²−2.2922a+59.604, 0.0, −0.0102a²+1.2922a+40.396), and
point E (0.0208a²−2.0723a+47.748, −0.0208a²+1.0723a+52.252, 0.0),
or on the straight lines AB and FE (excluding the points A, B, F, and E).

29. A composition comprising a refrigerant, the refrigerant comprising HFO-1132a, R32, R1234ze, and R1234yf in a total amount of 99.5 mass % or more based on the entire refrigerant,
wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 5.0≥x≥1.5, coordinates (x,y,z) in a ternary composition diagram in which the sum of R32, R1234yf, and R1234ze is (100−a) mass % are within the range of a figure surrounded by straight lines AB, BH, HG, and GA that connect the following four points:
point A (74.0, −a+26.0, 0.0),
point B (73.9, 0.0, −a+26.1),
point H (−0.1143a²+2.3143a+62.686, 0.0, 0.1143a²−3.3143a+37.314),
and
point G (−0.0505a²+2.6396a+34.049, 0.0505a²−3.6396a+65.951, 0.0),
or on the straight lines AB and HG (excluding the points A, B, H, and G);
if 7.5≥x>5.0, coordinates (x,y,z) in the ternary composition diagram are within the range of a figure surrounded by straight lines AB, BH, HG, and GA that connect the following four points:
point A (74.0, −a+26.0, 0.0),
point B (73.9, 0.0, −a+26.1),
point H (−0.072a²+1.9a+63.7, 0.0, 0.072a²−2.9a+36.3), and
point G (−0.0505a²+2.6396a+34.049, 0.0505a²−3.6396a+65.951, 0.0),
or on the straight lines AB and HG (excluding the points A, B, H, and G); or
if 10.0≥x>7.5, coordinates (x,y,z) in the ternary composition diagram are within the range of a figure surrounded by straight lines AR, RG, and GA that connect the following three points:
point A (74.0, −a+26.0, 0.0),
point R (73.9, 1.12a−8.4, −2.12a+34.5), and
point G (−0.0505a²+2.6396a+34.049, 0.0505a²−3.6396a+65.951, 0.0),
or on the straight lines AR and RG (excluding the points A and G).

30. A composition comprising a refrigerant, the refrigerant comprising HFO-1132a, R32, R1234ze, and R1234yf in a total amount of 99.5 mass % or more based on the entire refrigerant,
wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines A′B′, B′D, DC, and CA′ that connect the following four points:
point A′ (59.0, −a+41.0, 0),
point B′ (58.9, 0.0, −a+41.1),
point D (0.0098a²−2.1856a+39.064, 0.0, −0.0098a²+1.1856a+60.936), and
point C (0.0138a²−1.6252a+26.785, −0.0138a²+0.6252a+73.215, 0.0),
or on the straight lines A′B′ and DC (excluding the points A′, B′, D, and C).

31. A composition comprising a refrigerant, the refrigerant comprising HFO-1132a, R32, R1234ze, and R1234yf in a total amount of 99.5 mass % or more based on the entire refrigerant,
wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant, coordinates (x,y,z) in a ternary composition diagram in which the sum of R32, R1234yf, and R1234ze is (100−a) mass % are within the range of a figure surrounded by straight lines A′B′, B′F, FE, and EA′ that connect the following four points:
point A′ (59.0, −a+41.0, 0.0),
point B′ (58.9, 0.0, −a+41.1),
point F (0.0102a²−2.2922a+59.604, 0.0, −0.0102a²+1.2922a+40.396), and
point E (0.0208a²−2.0723a+47.748, −0.0208a²+1.0723a+52.252, 0.0),
or on the straight lines A′B′ and FE (excluding the points A′, B′, F, and E).

32. A composition comprising a refrigerant, the refrigerant comprising HFO-1132a, R32, R1234ze, and R1234yf in a total amount of 99.5 mass % or more based on the entire refrigerant,
wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 5.0≥x≥1.5, coordinates (x,y,z) in a ternary composition diagram in which the sum of R32, R1234yf, and R1234ze is (100−a) mass % are within the range of a figure surrounded by straight lines A′P, PG, and GA′ that connect the following three points:
point A′ (59.0, −a+41.0, 0.0),
point P (−0.019a²+0.1524a+58.714, −0.2571a²+4.1571a+9.5429, 0.2761a²−5.3095a+31.7431), and
point G (−0.0505a²+2.6396a+34.049, 0.0505a²−3.6396a+65.951, 0.0),
or on the straight lines A′P and PG (excluding the points A′ and G); or
if 10.0≥x>5, coordinates (x,y,z) in the ternary composition diagram are within the range of a figure surrounded by straight lines A′P, PG, and GA′ that connect the following three points:
point A′ (59.0, −a+41.0, 0.0),
point P (59.0, −0.136a²+2.94a+12.6, 0.136a²−3.94a+28.4), and
point G (−0.0505a²+2.6396a+34.049, 0.0505a²−3.6396a+65.951, 0.0),
or on the straight lines A′P and PG (excluding the points A′ and G).

33. The composition according to claim 24, which is for use as an alternative refrigerant for R410A.

34. A composition comprising a refrigerant, the refrigerant comprising HFO-1132a, R32, R1234ze, and R1234yf in a total amount of 99.5 mass % or more based on the entire refrigerant,
wherein
when the mass % of R32 is represented by x, the mass % of R1234yf is represented by y, the mass % of R1234ze is represented by z, and the mass % of HFO-1132a is represented by a, based on the sum of R32, R1234yf, R1234ze, and HFO-1132a in the refrigerant,
if 1.9?x21.5, coordinates (x,y,z) in a ternary composition diagram in which the sum of R32, R1234yf, and R1234ze is (100−a) mass % are within the range of a figure surrounded by straight lines A″T, TM, and MA″ that connect the following three points:
point A″ (21.8, −a+78.2, 0.0),
point T (21.5, −15.0a+28.5, 14.0a+50.0), and
point M (0.0035a²−0.9809a+10.358, −0.0035a²−0.0191a+89.642, 0.0),
or on the straight lines A″T and TM (excluding the points A″ and M); or
if 10.0≥x>1.9, coordinates (x,y,z) in the ternary composition diagram are within the range of a figure surrounded by straight lines A″B″, B″L, LM, and MA″ that connect the following four points:
point A″ (21.8, −a+78.2, 0.0),
point B″ (0.0108a+21.473, 0.0, −1.0108a+78.527),
point L (0.0098a²−1.2237a+23.804, 0.0, −0.0098a²+0.2237a+76.196), and
point M (0.0035a²−0.9809a+10.358, −0.0035a²−0.0191a+89.642, 0.0),
or on the straight lines A″B″ and LM (excluding the points A″, B″, L, and M).

35. The composition according to claim 34, which is for use as an alternative refrigerant for R404A.

36. The composition according to claim 24, which is for use as a working fluid for a refrigerating machine, the composition further comprising a refrigeration oil.

37. A refrigerating machine comprising the composition according to claim 24 as a working fluid.

38. A method for operating a refrigerating machine, comprising circulating the composition according to claim 24 as a working fluid in a refrigerating machine.

39. Use of the composition according to claim 24 as an alternative refrigerant for R410A.

40. Use of the composition according to claim 34 as an alternative refrigerant for R404A.
